(19) United States
(12) Patent Application Publication
(10) Pub. No.: US 2011/0049370 A1
(43) Pub. Date: Mar. 3, 2011

(54) Radiographic image capturing apparatus, radiographic image capturing system, and radiographic image capturing method

(75) Inventors: Yutaka Yoshida, Kanagawa-ken (JP); Yasunori Ohta, Kanagawa-ken (JP); Naoyuki Nishino, Kanagawa-ken (JP)

(73) Assignee: FUJIFILM Corporation, Tokyo (JP)

(21) Appl. No.: 12/805,709

(22) Filed: Aug. 16, 2010

(30) Foreign Application Priority Data
Aug. 25, 2009 (JP) 2009-194679

(51) Int. Cl. G01J 1/42

(52) U.S. Cl. 250/354.1; 250/393

(57) ABSTRACT

A radiographic image capturing apparatus of a radiographic image capturing system includes a radiation source for outputting a radiation, a cassette housing therein a radiation detector for detecting the radiation which is transmitted through a subject when the subject is irradiated with the radiation by the radiation source, and converting the detected radiation into a radiographic image, a camera for capturing an image of at least the cassette, and a communication unit for sending the image of the cassette which is captured by the camera to an external circuit.

### CROSS-REFERENCE TO RELATED APPLICATION

This application is based upon and claims the benefit of priority from Japanese Patent Application No. 2009-194679 filed on Aug. 25, 2009, of which the contents are incorporated herein by reference.

### BACKGROUND OF THE INVENTION

1. Field of the Invention

The present invention relates to a radiographic image capturing apparatus, a radiographic image capturing system, and a radiographic image capturing method for applying a radiation from a radiation source to a subject and detecting the radiation that has passed through the subject and converting the detected radiation into a radiation image with a radiation detector.

2. Description of the Related Art

In the medical field, there have widely been used radiographic image capturing apparatus which apply a radiation to a subject and guide the radiation that has passed through the subject to a radiation conversion panel (radiation detector), which captures a radiographic image from the radiation. Known forms of the radiation conversion panel include a conventional radiation film for recording a radiographic image by way of exposure, and a stimulable phosphor panel for storing a radiation energy representing a radiographic image in a phosphor and reproducing the radiographic image as stimulated light by applying stimulating light to the phosphor. The radiation film with the recorded radiographic image is supplied to a developing device to develop the radiographic image, or the stimulable phosphor panel is supplied to a reading device to read the radiographic image as a visible image.

In the operating room or the like, it is necessary to read a recorded radiographic image immediately from a radiation conversion panel after the radiographic image is captured for the purpose of quickly and appropriately treating the patient. As a radiation detector which meets such a requirement, there have been developed a radiation detector of the direct conversion type having a solid-state detector for converting a radiation directly into an electric signal and a radiation detector of the indirect conversion type having a scintillator for temporarily converting a radiation into visible light and a solid-state detector for converting the visible light into an electric signal.

The radiation detector described above is housed in a radiation detecting cassette which is permeable to the radiation.

As disclosed in Japanese Laid-Open Patent publication No. 2003-093354, the radiographic image capturing apparatus are developed on the assumption that they will be used to capture radiographic images of patients in hospitals.

There are potential demands for capturing radiographic images outside hospitals. To meet such demands, radiographic image capturing apparatus mounted on motor vehicles dedicated for medical examination have been proposed in the art (see Japanese Laid-Open Patent Publication No. 2008-206740 and Japanese Laid-Open Patent Publication No. 2002-306463). However, the proposed radiographic image capturing apparatus on the medical examination motor vehicles are relatively large in size. Needs have arisen for capturing radiographic images of persons who suffer from natural disasters at disaster sites or persons who are receiving home-care services at their homes. However, the existing medical examination motor vehicles cannot be used in the former application as they find it difficult to get to disaster sites. Though the existing medical examination motor vehicles may be driven to the homes of persons who are receiving home-care services, the image capturing process is highly burdensome to the people to be imaged because they have to be taken from their homes into the medical examination motor vehicle in order to capture radiographic images thereof. Therefore, there have been demands for small-size portable radiographic image capturing apparatus for use at natural disaster sites or homes receiving home-care services.

There has been developed a portable radiographic image capturing apparatus which can be folded into a compact form in its entirety as disclosed in Japanese Laid-Open Patent Publication No. 11-104117. In addition, field-emission-type radiation sources based on the carbon nanotube (CNT) technology have been proposed as disclosed in Japanese Laid-Open Patent Publication No. 2007-103016 and AIST: Press Release “Development of Portable X-ray Sources Using Carbon Nanostructures” [online], Mar. 19, 2009, National Institute of Advanced Industrial Science and Technology, [retrieved Jul. 8, 2009, Internet <URL: http://www.aist.go.jp/aist_j/press_release/pr2009/pr20090319/pr20090319.html>. It has been expected to have small-size, lightweight radiographic image capturing apparatus including radiation sources, available in the art.

When a radiographic image capturing apparatus including a radiation source is reduced in overall size and weight, it is easy to carry around. Specifically, a radiographic image capturing apparatus is carried to a disaster site or a home receiving home-care services. At the disaster site or the home, the radiographic image capturing apparatus is assembled into an operational form so that it is ready to capture radiographic images.

In Japan, persons who are legally permitted to engage in the business of applying a radiation to a human body (to capture a radiographic image of the human body) are limited to doctors and dentists (hereinafter simply referred to as “doctors”) and medical radiological technicians (hereinafter simply referred to as “radiological technicians”) according to the Radiology Technicians Act. If a doctor or a radiological technician who has the legal authority about the application of a radiation to a subject is unable to go to a disaster site or a home receiving home-care services for some reasons, then a person other than the doctor or the radiological technician, i.e., a person who is not qualified as a radiological technician according to the Radiology Technicians Act (hereinafter referred to as “operator”), may take a radiographic image capturing apparatus to the site and perform a preparatory procedure to make the radiographic image capturing apparatus ready to capture radiographic images, e.g., to position a body region of the subject to be imaged with respect to the cassette housing the radiation detector. However, the operator is not legally permitted to capture radiographic images of the subject with the radiographic image capturing apparatus. According to the present practice, the qualified person such as a doctor or a radiological technician needs to go to the disaster site or the home in order to capture radiographic images of the subject with the radiographic image capturing apparatus.

To eliminate the above shortcomings, the technologies disclosed in Japanese Laid-Open Patent Publication No. 2003-093354 and Japanese Laid-Open Patent Publication No. 2008-206740 may be applied to capture radiographic images of a subject according to the instructions from a doctor or a radiological technician who is staying in a place (e.g., a medical organization or a medical examination motor vehicle) where they cannot see the subject directly.

According to the technology disclosed Japanese Laid-Open Patent Publication No. 2003-093354, an image (radiographic image) of the affected region of an emergency patient (subject) who has been carried into a medical organization is sent to the mobile terminal of a doctor who is not available at the medical organization, and the doctor is asked to give instructions as to a next radiographic image of the emergency patient to be captured. If the technology disclosed Japanese Laid-Open Patent Publication No. 2003-093354 is directly applied, then the image of the affected region of the emergency patient which is sent to the mobile terminal of the doctor to seek the doctor's instructions as to a next radiographic image to be captured may possibly be a radiographic image which has been captured without the approval of the doctor. In addition, since the image of the affected region of the emergency patient needs to be sent to the mobile terminal of the doctor to seek the doctor's instructions as to a next radiographic image to be captured, the doctor is unable to instruct any person at the site to capture a radiographic image of the patient in real time.

According to the technology disclosed in Japanese Laid-Open Patent Publication No. 2008-206740, the exposure of a subject to a radiation is interrupted based on an optical image representing a body movement of the subject. Even if the technology disclosed in Japanese Laid-Open Patent Publication No. 2008-206740 is directly applied, the doctor is unable to instruct any person at the site to capture a radiographic image of the patient in real time.

### SUMMARY OF THE INVENTION

It is an object of the present invention to provide a radiographic image capturing apparatus, a radiographic image capturing system, and a radiographic image capturing method which make it possible to capture a radiographic image of a subject at a disaster site or a home receiving home-care services even without the need for a doctor or a radiological technician to go to the disaster site or the home.

To achieve the above object, there is provided in accordance with the present invention a radiographic image capturing apparatus comprising a radiation source for outputting a radiation, a radiation detector for detecting the radiation which is transmitted through a subject when the subject is irradiated with the radiation by the radiation source, and converting the detected radiation into a radiographic image, a cassette housing the radiation detector therein, the cassette being permeable to the radiation, a camera for capturing an image of at least the cassette, and a camera image communication unit for sending the image of the cassette which is captured by the camera to a waiting-place communication unit, the waiting-place communication unit being disposed in a waiting place where a doctor or radiological technician who has the legal authority about the application of the radiation to the subject waits and is unable to see the subject directly.

There is also provided in accordance with the present invention a radiographic image capturing system comprising a radiographic image capturing apparatus including a radiation source for outputting a radiation, a radiation detector for detecting the radiation which is transmitted through a subject when the subject is irradiated with the radiation by the radiation source, and converting the detected radiation into a radiographic image, a cassette housing the radiation detector therein, the cassette being permeable to the radiation, a camera for capturing an image of at least the cassette, and a camera image communication unit for sending the image of the cassette which is captured by the camera to an external circuit, a waiting-place communication unit for receiving the image of the cassette from the camera image communication unit, the waiting-place communication unit being disposed in a waiting place where a doctor or radiological technician who has the legal authority about the application of the radiation to the subject waits and is unable to see the subject directly, and a console electrically connected to the waiting-place communication unit, for being supplied with the image of the cassette from the waiting-place communication unit.

There is further provided in accordance with the present invention a radiographic image capturing method comprising the steps of capturing an image of a cassette housing therein at least a radiation detector with a camera, sending the image of the cassette which is captured by the camera to a waiting-place communication unit which is disposed in a waiting place where a doctor or radiological technician who has the legal authority about the application of a radiation to a subject waits and is unable to see the subject directly, sending an instruction from the waiting-place communication unit to the radiation source to output the radiation thereby to cause the radiation source to output and apply the radiation to the subject, when the image of the cassette sent to the waiting-place communication unit includes a body region of the subject to be imaged, and detecting the radiation which is transmitted through the subject and the cassette and converting the detected radiation into a radiographic image with the radiation detector.

According to the present invention, at a disaster site or a home receiving home-care services, the camera captures an image of at least the cassette, and the camera image communication unit sends the image of the cassette which is captured by the camera to the waiting-place communication unit in the waiting place. Based on the image of the cassette which is received by the waiting-place communication unit, the doctor or radiological technician who is waiting in the waiting place where the doctor or radiological technician is unable to see the subject directly can instruct the operator of the radiographic image capturing apparatus at the disaster site or the home to capture a radiographic image of the subject in real time. Therefore, the doctor or radiological technician can capture a radiographic image of the subject without going themselves to the disaster site or the home.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a radiographic image capturing apparatus and a radiographic image capturing system according to an embodiment of the present invention;

FIG. 2 a perspective view of the radiographic image capturing apparatus shown in FIG. 1;

FIG. 3 is a side elevational view of the radiographic image capturing apparatus shown in FIGS. 1 and 2;

FIG. 4 is a side elevational view of the radiographic image capturing apparatus shown in FIGS. 1 and 2;

FIG. 5 is a perspective view showing the manner in which the radiographic image capturing apparatus shown in FIGS. 1 and 2 is carried;

FIG. 6 is a cross-sectional view, partly shown in block form, of internal details of a radiation source device shown in FIG. 1;

FIG. 7 is a plan view, partly in cross section, of a cassette shown in FIGS. 1 and 2;

FIG. 8 is a schematic view showing an array of pixels of a radiation detector of the radiographic image capturing apparatus shown in FIG. 1;

FIG. 9 is a block diagram of a circuit arrangement of the radiation detector in the cassette;

FIG. 10 is a block diagram of the radiographic image capturing apparatus shown in FIG. 1;

FIG. 11 is a block diagram of a medical organization shown in FIG. 1;

FIG. 12 is a flowchart of an image capturing sequence of the radiographic image capturing apparatus and the radiographic image capturing system shown in FIG. 1;

FIG. 13 is a flowchart of a preparatory procedure in step S5 shown in FIG. 12;

FIGS. 14A through 14C are views showing by way of example images displayed on a mobile information terminal and/or a console;

FIGS. 15A through 15C are views showing by way of example images displayed on the mobile information terminal and/or the console;

FIG. 16 is a perspective view showing the manner in which the mobile information terminal, the radiation source device, and the cassette are charged in the medical organization;

FIG. 17 is a perspective view of a radiographic image capturing apparatus and a radiographic image capturing system according to a first modification;

FIG. 18 is a perspective view of a radiographic image capturing apparatus and a radiographic image capturing system according to a second modification;

FIG. 19 is a perspective view of a radiographic image capturing apparatus and a radiographic image capturing system according to a third modification;

FIG. 20 is a perspective view of a radiographic image capturing apparatus and a radiographic image capturing system according to a fourth modification;

FIG. 21 is a perspective view of a radiographic image capturing apparatus and a radiographic image capturing system according to a fifth modification;

FIG. 22 is a perspective view of a radiographic image capturing apparatus and a radiographic image capturing system according to a sixth modification;

FIG. 23 is a perspective view of a radiographic image capturing apparatus and a radiographic image capturing system according to a seventh modification;

FIG. 24 is a perspective view of a radiographic image capturing apparatus and a radiographic image capturing system according to an eighth modification;

FIG. 25 is a perspective view of a radiographic image capturing apparatus and a radiographic image capturing system according to a ninth modification;

FIGS. 26A and 26B are views of a portion of a radiographic image capturing apparatus and a radiographic image capturing system according to a tenth modification;

FIGS. 27A and 27B are views of a portion of the radiographic image capturing apparatus and the radiographic image capturing system according to the tenth modification;

FIGS. 28A and 28B are views of a portion of the radiographic image capturing apparatus and the radiographic image capturing system according to the tenth modification;

FIGS. 29A and 29B are views of a portion of the radiographic image capturing apparatus and the radiographic image capturing system according to the tenth modification;

FIGS. 30A and 30B are views of a portion of the radiographic image capturing apparatus and the radiographic image capturing system according to the tenth modification;

FIG. 31A is a cross-sectional view of a portion of a radiographic image capturing apparatus;

FIG. 31B is a view showing by way of example an image displayed on a mobile information terminal and/or a console of the radiographic image capturing apparatus shown in FIG. 31A;

FIG. 32A is a cross-sectional view of a portion of a radiographic image capturing apparatus;

FIG. 32B is a view showing by way of example an image displayed on a mobile information terminal and/or a console of the radiographic image capturing apparatus shown in FIG. 32A;

FIG. 33A is a view showing by way of example an image displayed on the mobile information terminal and/or the console after a radiographic image has been captured by the radiographic image capturing apparatus shown in FIG. 31A;

FIG. 33B is a view showing by way of example an image displayed on the mobile information terminal and/or the console after a radiographic image has been captured by the radiographic image capturing apparatus shown in FIG. 32A;

FIG. 34 is a view of a portion of the radiographic image capturing apparatus and the radiographic image capturing system according to the eleventh modification;

FIG. 35 is a perspective view of the radiation source device shown in FIG. 34;

FIGS. 36A and 36B are cross-sectional views of a portion of a radiographic image capturing apparatus; and

FIGS. 37A and 37B are perspective views of other examples of the radiation source device shown in FIG. 35.

### DESCRIPTION OF THE PREFERRED EMBODIMENTS

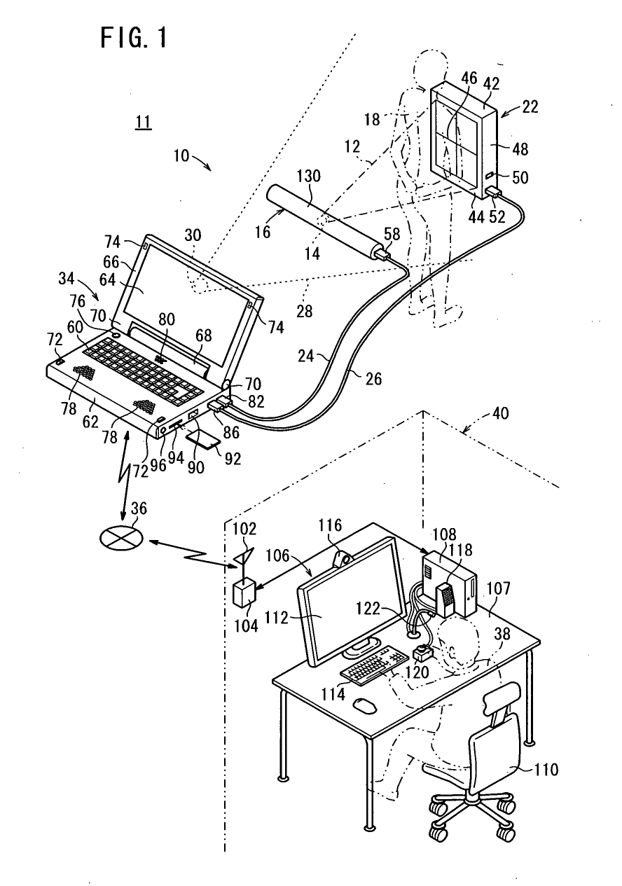

Radiographic image capturing apparatus and radiographic image capturing systems incorporating such radiographic image capturing apparatus according to preferred embodiments of the present invention, in relation to radiographic image capturing methods carried out thereby, will be described in detail below with reference to FIGS. 1 through 37B.

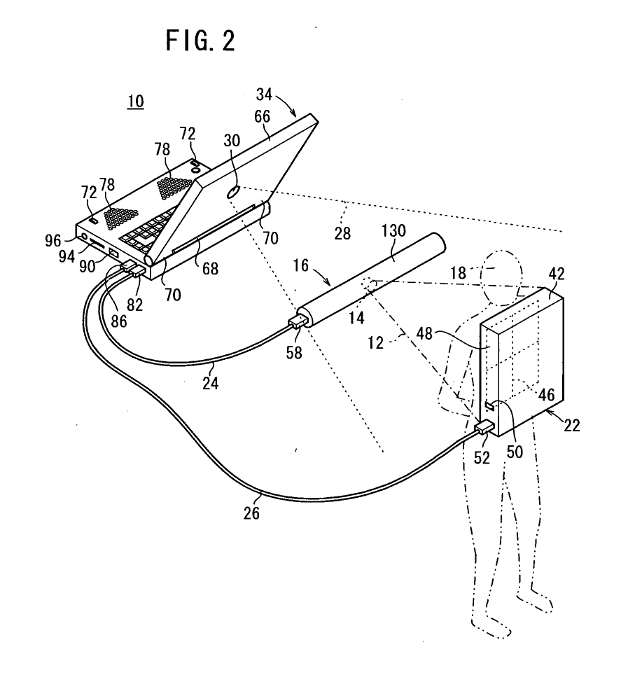

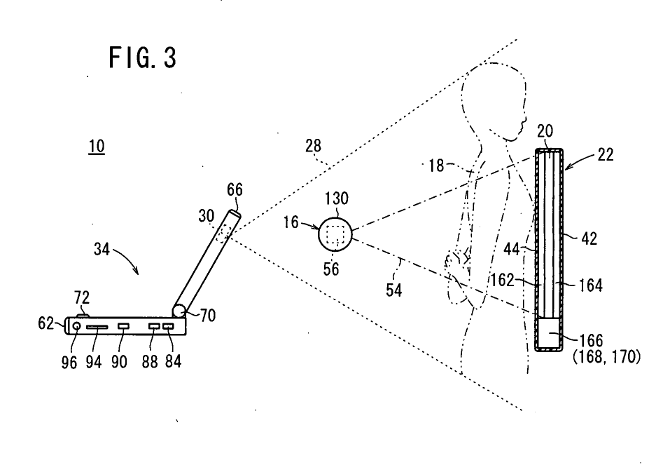

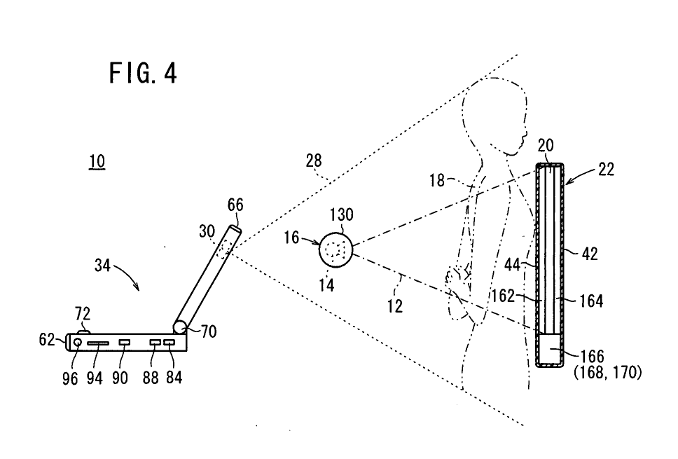

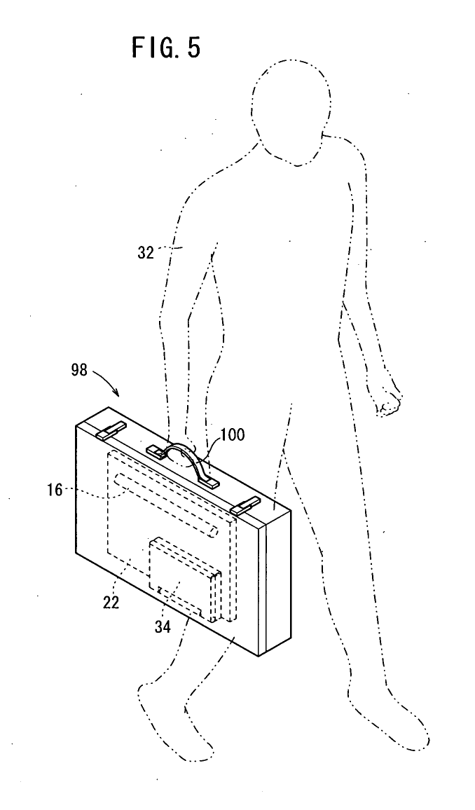

As shown in FIGS. 1 and 2, a radiographic image capturing apparatus 10 as part of a radiographic image capturing system 11 according to an embodiment of the present invention includes a radiation source device 16 housing therein a radiation source 14 for emitting a radiation 12 and made of a material permeable to the radiation 12, a cassette 22 housing therein a radiation detector 20 (see FIGS. 3 and 4) for converting the radiation 12 that has passed through a subject 18 into a radiographic image and made of a material permeable to the radiation 12, and a mobile information terminal (controller, PC) 34 electrically connected to the radiation source device 16 by a USB cable (communication cable) 24, electrically connected to the cassette 22 by a USB cable (communication cable) 26, and incorporating a web camera 30 for capturing an image of a predetermined imaging area 28. The mobile information terminal 34 can be operated by an operator 32 (see FIG. 5) of the radiographic image capturing apparatus 10. The mobile information terminal 34 is capable of sending signals to and receiving signals from a medical organization 40 (waiting place) to which a doctor (or a radiological technician) 38 belongs, via a network 36 such as a public network or the like, by way of wireless communications.

The operator 32 refers to a person who is no qualified as a medical radiological technician according to the Radiology Technicians Act of Japan, or specifically a person other than doctors and dentists (hereinafter simply referred to as “doctors”) and medical radiological technicians (hereinafter simply referred to as “radiological technicians”) who have the legal authority about the application of the radiation 12 to the subject 18. In the present embodiment, the subject 18 is present at a disaster site or a home receiving home-care services, whereas the doctor (or radiological technician) 38 is present (waiting) in a remote medical organization 40 where the doctor (or radiological technician) 38 is unable to directly see the subject 18. The doctor (or radiological technician) 38 is unable to go to the disaster site or the home for some reasons, and the operator 32 goes in lieu of the doctor 38 to the disaster site or the home. Hereinafter, the reference numeral 38 will be used to represent a doctor.

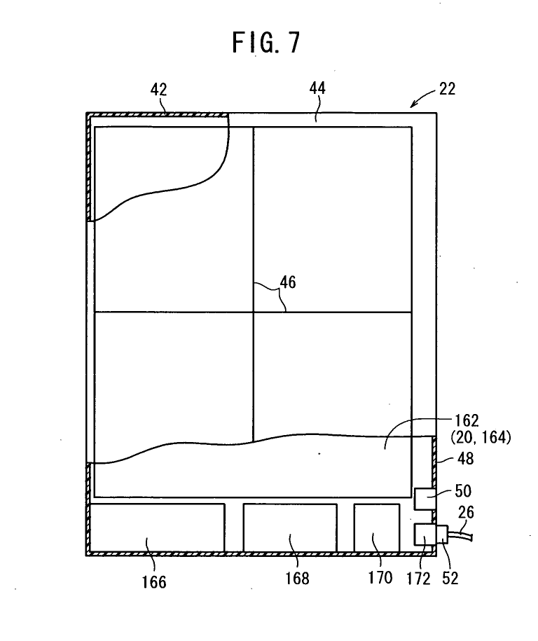

As shown in FIGS. 1 through 4 and 7, the cassette 22 has a substantially rectangular housing 42 made of a material permeable to the radiation 12 and including a surface facing the radiation source device 16. The surface facing the radiation source device 16 will be referred to as an irradiated surface 44 which is irradiated with the radiation 12. The cassette 22 has guide lines 46 disposed in an irradiated area (irradiated field), which is irradiated with the radiation 12, of the irradiated surface 44 and serving as a reference for an image capturing area and an image capturing position. The guide lines 46 provide an outer frame (irradiated field) which is substantially aligned with the outer edge of the radiation detector 20, as shown in FIG. 7. One side 48 of the housing 42 supports a switch 50 for activating the cassette 22 and is connected to a connector 52 on one end of the USB cable 26.

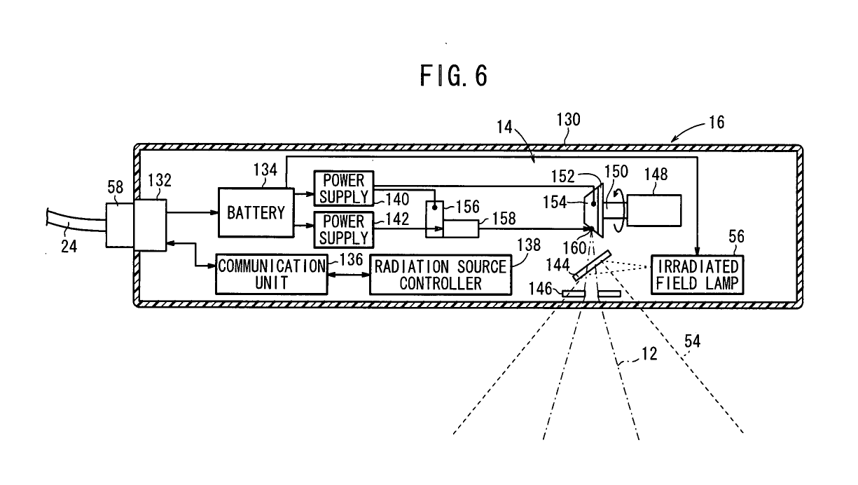

As shown in FIGS. 3 and 6, the radiation source device 16 has a substantially cylindrical casing 130 made of a material permeable to the radiation 12, the substantially cylindrical casing 130 being substantially rectangular in cross section. The casing 130 houses therein the radiation source 14 and an irradiated field lamp 56 for emitting irradiation light 54. The irradiated field lamp 56 applies the irradiation light 54 to the irradiated surface 44 before the radiation source 14 outputs the radiation 12, thereby displaying the irradiated field on the irradiated surface 44.

It is assumed that a straight line interconnecting a focused point 160, to be described later, of the radiation source 14 and a central position of the guide lines 46 (see FIGS. 1, 2, and 7), i.e., a point of intersection of the criss-crossing guide lines 46, is substantially perpendicular to the irradiated surface 44. If the distance (imaging distance) between the focused point 160 and the central position of the crisscross guide lines 22 is set to a source-to-image distance (SID), then the outer edge of the irradiated field that is displayed on the irradiated surface 44 when the irradiation light 54 is applied thereto is essentially aligned with the outer frame of the guide lines 46. The portion of the casing 130 through which the irradiation light 54 passes should preferably be made of a material permeable to the irradiation light 54. As shown in FIGS. 1, 2, and 6, the casing 130 has a side connected to a connector 58 on one end of the USB cable 24.

As shown in FIGS. 1 through 4 and 16, the mobile information terminal 34 comprises a notebook-sized personal computer including an operating unit 60 such as a keyboard, etc., disposed on an upper surface (facing a lid 66) of a main body 62 and a display unit 64 disposed on a lower surface (facing the operating unit 60) of the lid 66. In the present embodiment, the mobile information terminal 34 is illustrated as a notebook-sized personal computer. However, the mobile information terminal 34 may be one of any mobile terminals having various functions including the operating unit 60 and the display unit 64, e.g., a mobile phone or a PDA (Personal Digital Assistant).

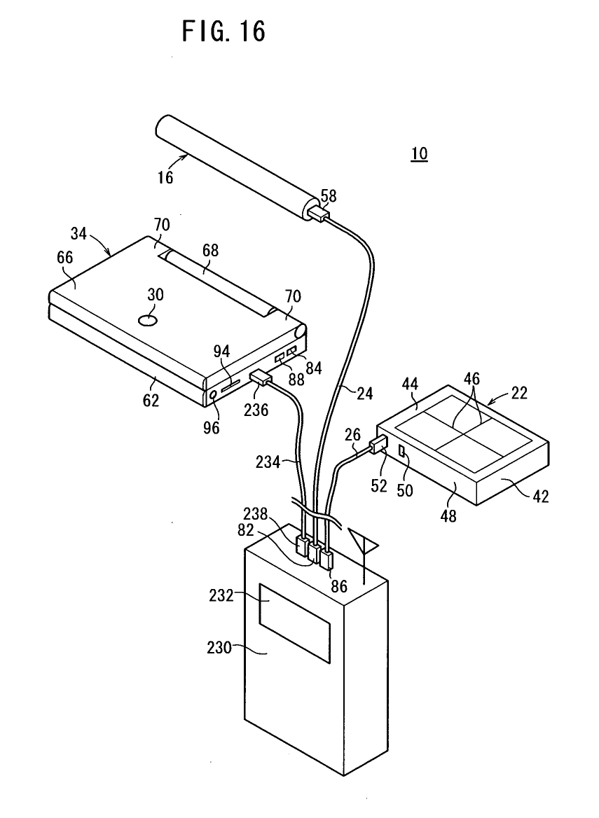

When the mobile information terminal 34 is not in use, the main body 62 and the lid 66 are folded one on the other about a shaft 68 on one side of the main body 62 and two hinges 70 connected to the respective ends of the shaft 68, as shown in FIG. 16. The upper surface of the main body 62 has two teeth 72, and the lower surface of the lid 66 has two recesses 74 corresponding to the respective teeth 72. When the upper surface of the main body 62 and the lower surface of the lid 66 are brought into contact with each other at the time the mobile information terminal 34 is not in use, the teeth 72 fit respectively into the recesses 74, keeping the main body 62 and the lid 66 folded one on the other.

When the mobile information terminal 34 is in use, the lid 66 is turned away from the main body 62 about the shaft 68 and the hinges 70, unfolding the main body 62 and the lid 66 away from each other to an operational position shown in FIGS. 1 through 4.

On the upper surface of the main body 62 around the operating unit 60, there are disposed a power supply switch 76 for activating the mobile information terminal 34, speakers (sound output unit) 78 for outputting sounds, and a microphone 80 for detecting the voices of the subject 18 and the operator 32. On a side of the main body 62, there are disposed a USB terminal 84 (see FIG. 16) for connecting to a connector 82 on the other end of the USB cable 24, a USB terminal 88 for connecting to a connector 86 on the other end of the USB cable 26, a USB terminal 90 for sending information to and receiving information from an external device, a card slot 94 for inserting a memory card 92 therein, and an input terminal 96 for connection to an AC adapter.

The lid 66 has on its upper surface the web camera 30 as an optical camera. The web camera 30 and the mobile information terminal 34 are integrally combined with each other.

The integral structure of the web camera 30 and the mobile information terminal 34 is not limited to the structure in which the mobile information terminal 34 has a built-in web camera 30 shown in FIGS. 1 through 4, but may include the structure in which a mobile information terminal 34 is integrally connected to a web camera 30 at least at the time the radiographic image capturing apparatus 10 is in use. Specifically, the integral structure of the web camera 30 and the mobile information terminal 34 includes the cases: (1) the web camera 30 and the mobile information terminal 34 are connected to each other by cables attached to the radiographic image capturing apparatus 10; (2) the web camera 30 and the mobile information terminal 34 are connected to each other by a cable prepared by the operator 32; and (3) the web camera 30 and the mobile information terminal 34 are connected to each other when in use, whereas the web camera 30 and the mobile information terminal 34 are separable from each other during maintenance or when not in use.

When the lid 66 is turned away from the main body 62 until the upper surface of the lid 66 faces the cassette 22, the radiation source device 16, and the subject 18, and the operator 32 turns on the power supply switch 76 to activate the mobile information terminal 34, the web camera 30 captures an image of at least the irradiated field (the range of the guide lines 46) of the irradiated surface 44 as the imaging area 28. More preferably, as shown in FIGS. 1 through 4, while the subject 18 is being positioned between the radiation source device 16 and the cassette 22, the web camera 30 captures an image of an area including the radiation source device 16, the subject 18, and the cassette 22 as the imaging area 28.

The web camera 30 captures successive images of the imaging area 28 and outputs the captured successive images as camera images (moving images). The web camera 30 can also capture images of the imaging area 28 at intermittent intervals (intermittently) and output the captured images as camera images (still images) at intermittent intervals or output the captured images as camera images (still images) at predetermined times.

FIG. 5 shows the manner in which the radiographic image capturing apparatus 10 is carried by the operator 32.

When the radiographic image capturing apparatus 10 is carried by the operator 32, the radiation source device 16, the cassette 22, and the folded mobile information terminal 34 is housed in an attaché case 98 with the connectors 52, 58, 82, 86 removed to electrically disconnect the USB cables 24, 26. The operator 32 can grip a handle 100 and carry the attaché case 98 from the medical organization 40 to a desired place, e.g., a disaster site or a home receiving home-care services. At the place to which attaché case 98 is carried, the operator 32 can take out the radiation source device 16, the cassette 22, and the folded mobile information terminal 34 from the attaché case 98, and assemble them into the configuration shown in FIGS. 1 through 4. The operator 32 can then perform a preparatory procedure to make the radiographic image capturing apparatus 10 ready for capturing radiographic images of a person at a disaster site or a home receiving home-care services.

The radiographic image capturing apparatus 10 according to the present embodiment can thus be referred to as a portable radiographic image capturing apparatus integrally combined with the web camera 30 and the mobile information terminal 34. The person who is to be imaged at a disaster site or a home receiving home-care services by the radiographic image capturing apparatus 10 will be referred to as the subject 18.

As shown in FIG. 1, the medical organization 40 includes a communication unit (waiting-place communication unit, wireless communication unit) 104 having an antenna 102 for sending signals to and receiving signals from the mobile information terminal 34 via the network 36 by way of wireless communications. A console 106 is electrically connected to the communication unit 104.

The console 106 is connected to a radiology information system (RIS), not shown, which generally manages radiographic images and other information that are handled in a radiological department of the medical organization 40. The RIS is connected to a hospital information system (HIS), not shown, which generally manages medical information in the medical organization 40.

The console 106 comprises a main body 108 for carrying out processing sequences, the main body 108 being placed on a desk 107 in a room attended by the doctor 38 in the medical organization 40, a display unit 112 for displaying images and information for the doctor 38 seated on a chair 110 at the desk 107, an operating unit 114 such as a keyboard, etc. operable by the doctor 38, a web camera 116 mounted on the upper end of the display unit 112 for capturing an image of the doctor 38, a speaker 118 for outputting sounds, an exposure switch 120 which can be turned on by the doctor 38 to instruct the radiation source 14 to emit the radiation 12, and a microphone 122 for detecting the voice of the doctor 38.

As described above, the mobile information terminal 34 and the communication unit 104 send signals to and receive signals from each other via the network 36 by way of wireless communications.

The mobile information terminal 34 can send a camera image output from the web camera 30, a radiographic image supplied from the cassette 22 (radiation detector 20) via the USB cable 26, and a sound signal representative of the voice of the operator 32 or the subject 18 detected by the microphone 80, through the antenna 102 to the communication unit 104 via the network 36 by way of wireless communications.

The communication unit 104 can send a camera image (a moving image, still images captured intermittently, or a still image captured at a predetermined time) of the doctor 38 captured by the web camera 116, an exposure control signal generated in the main body 108 when the doctor 38 turns on the exposure switch 120, and a voice signal representing the voice of the doctor 38 detected by the microphone 122, to the mobile information terminal 34 via the antenna 102 and the network 36 by way of wireless communications.

On the mobile information terminal 34, the display unit 64 is thus able to display a camera image in the imaging area 28 captured by the web camera 30, a radiographic image from the radiation detector 20, and/or a camera image of the doctor 38 captured by the web camera 116. The display unit 64 is also able to display information (character information) corresponding to the voice signals and the exposure control signal referred to above. The speakers 78 are able to output the voice of the doctor 38 and a sound depending on the exposure control signal (an alarm sound indicative of the start of the emission of the radiation 12 from the radiation source 14).

The mobile information terminal 34 sends a synchronization control signal generated based on the exposure control signal via the USB cables 24, 26 to the radiation source device 16 and the cassette 22 for thereby synchronizing the (start of) emission of the radiation 12 from the radiation source 14 and the detection and conversion of the radiation 12 into a radiographic image in the radiation detector 20 with each other.

On the console 106, the display unit 112 is able to display a camera image in the imaging area 28 captured by the web camera 30, a radiographic image from the radiation detector 20, and/or a camera image of the doctor 38 captured by the web camera 116, as is the case with the display unit 64. The display unit 112 is also able to display information (character information) corresponding to the voice signals and the exposure control signal referred to above. The speaker 118 is able to output the voice of the operator 32 or the subject 18 and a sound depending on the exposure control signal.

Internal structures of the radiation source device 16 and the cassette 22 will be described in specific detail with reference to FIGS. 6 through 9.

As shown in FIG. 6, the casing 130 of the radiation source device 16 houses therein the radiation source 14, the irradiated field lamp 56, a USB terminal 132 for connecting to the connector 58 on the USB cable 24, a battery 134 for supplying electric power to various components of the radiation source device 16, the battery 134 being chargeable from an external circuit, e.g., the mobile information terminal 34, via the USB cable 24, the connector 58, and the USB terminal 132, a communication unit (radiation source communication unit) 136, a radiation source controller 138 for controlling the radiation source 14, a mirror 144 made of a material permeable to the radiation 12, and a collimator 146 which is made of a material impermeable to the radiation 12, but permeable to the irradiation light 54.

The radiation source 14 comprises a field-emission-type radiation source similar to the field-emission-type radiation source disclosed in Japanese Laid-Open Patent Publication No. 2007-103016.

The radiation source 14 includes a disk-shaped rotary anode 152 mounted on a rotational shaft 150 that can be rotated about its own axis by a rotating mechanism 148, an annular target layer 154 disposed on the surface of the rotary anode 152 and made mainly of a metallic element of Mo or the like, a cathode 156 disposed in confronting relation to the rotary anode 152, and a field-emission-type electron source 158 disposed on the cathode 156 in confronting relation to the target layer 154.

The radiation source controller 138 controls the radiation source 14 to output the radiation 12 according to a synchronization control signal based on an exposure control signal, which is received from the mobile information terminal 34 (see FIGS. 1 through 5) via the USB cable 24, the connector 58, the USB terminal 132, and the communication unit 136.

Specifically, when the radiation source 14 is controlled by the radiation source controller 138, the rotating mechanism 148 rotates the rotational shaft 150 to rotate the rotary anode 152. The battery 134 supplies electric power to a power supply 142, which applies a negative voltage to the field-emission-type electron source 158. The battery 134 also supplies electric power to a power supply 140, which applies a voltage between the rotary electrode 152 and the cathode 156, i.e., applies a positive voltage to the rotary electrode 152 and applies a negative voltage to the cathode 156. The field-emission-type electron source 158 emits electrons that are accelerated and bombard the target layer 154 under the voltage applied between the rotary electrode 152 and the cathode 156. The electrons are focused onto and bombard a point 160 on the surface of the target layer 154, and the bombarded surface of the target layer 154 emits the radiation 12 from the focused point 160 at an intensity level depending on the applied electrons. The radiation 12 passes through the mirror 144, is constricted in its irradiation area by the collimator 146 and output from the radiation source device 16.

Until the radiation source controller 138 is supplied with the synchronization control signal from the mobile information terminal 34, the radiation source controller 138 controls the irradiated field lamp 56 to emit the irradiation light 54. The irradiation light 54 emitted from the irradiated field lamp 56 is reflected by the mirror 144 to the collimator 146, and is constricted in its irradiation area by the collimator 146 and output from the radiation source device 16.

As shown in FIGS. 3, 4, and 7, the cassette 22 houses therein a grid 162 for removing scattered rays of the radiation 12 from the subject 18 when the radiation source 14 applies the radiation 12 to the subject 18, the radiation detector 20, and a lead plate 164 for absorbing back scattered rays of the radiation 12, which are successively arranged in the order named from the irradiated surface 44 of the cassette 22 which faces the subject 18. The irradiated surface 44 of the cassette 22 may be constructed as the grid 162.

The radiation detector 20 may comprise a radiation detector of the indirect conversion type including a scintillator for converting the radiation 12 having passed through the subject 18 into visible light and solid-state detectors (hereinafter also referred to as pixels) made of amorphous silicon (a-Si) or the like for converting the visible light into an electric signal, or a radiation detector of the direct conversion type comprising solid-state detectors made of amorphous selenium (a-Se) or the like for converting the dose of the radiation 12 directly into an electric signal.

The switch 50 and a USB terminal 172 for connecting to the connector 52 on the USB cable 26 are disposed on the side 48 of the cassette 22.

The cassette 22 also houses therein a battery 166 for supplying electric power to various components of the cassette 22, the battery 166 being chargeable from an external circuit, e.g., the mobile information terminal 34, via the USB cable 26, the connector 52, and the USB terminal 172, a cassette controller 168 for controlling the radiation detector 20 with electric power supplied from the battery 166, and a communication unit 170 for sending and receiving signals including the information of the radiation 12 detected by the radiation detector 20, to and from the mobile information terminal 34 via the USB terminal 172, the connector 52, and the USB cable 26.

A plate of lead or the like should preferably be placed over the side surfaces of the cassette controller 168 and the communication unit 170 under the irradiated surface 44 to protect the cassette controller 168 and the communication unit 170 against damage which would otherwise be caused if irradiated with the radiation 12. The battery 166 supplies electric power to the radiation detector 20, the cassette controller 168, and the communication unit 170 in the cassette 22.

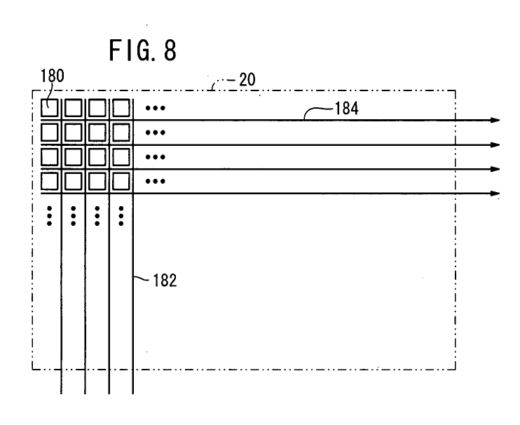

As shown in FIG. 8, the radiation detector 20 comprises a number of pixels 180 arrayed on a substrate, not shown, a number of gate lines 182 for supplying control signals to the pixels 180, and a number of signal lines 184 for reading electric signals output from the pixels 180.

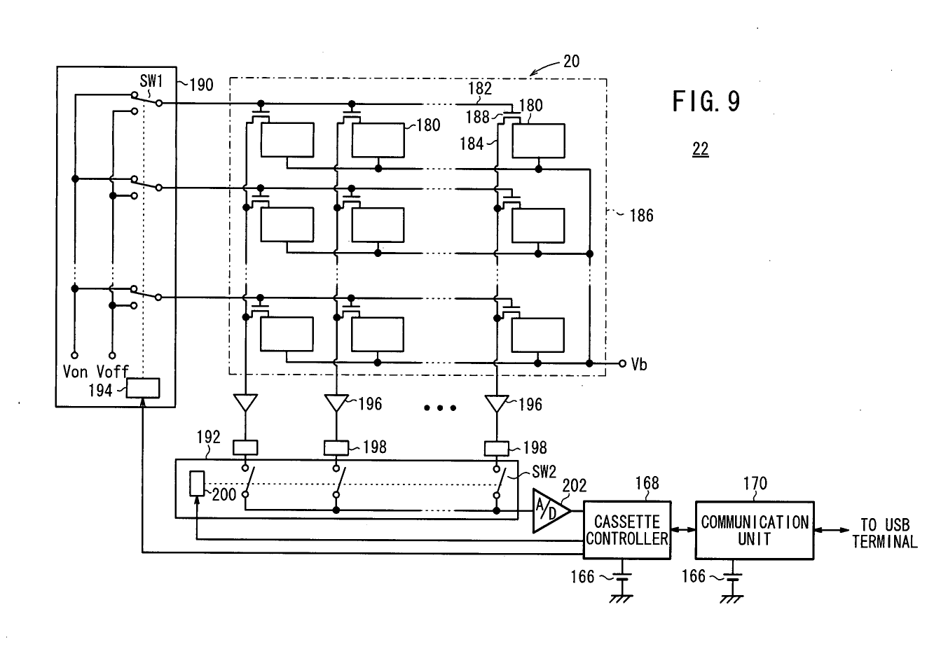

A circuit arrangement of the radiation detector 20, which is of the indirect conversion type, for example, that is housed in the cassette 22 will be described in detail below with reference to FIG. 9.

As shown in FIG. 9, the radiation detector 20 comprises an array of thin-film transistors (TFTs) 188 arranged in rows and columns and a photoelectric conversion layer 186 including the pixels 180 and made of a material such as amorphous silicon (a-Si) or the like for converting visible light into electric signals, the photoelectric conversion layer 186 being disposed on the array of TFTs 188. When the radiation 12 is applied to the radiation detector 20, the pixels 180 generate electric charges by converting visible light into analog electric signals. Then, when the TFTs 188 are turned on along each row at a time, the electric charges are read from the pixels 180 as an image signal.

The TFTs 188 are connected to the respective pixels 180. The gate lines 182 which extend parallel to the rows and the signal lines 184 which extend parallel to the columns are connected to the TFTs 188. The gate lines 182 are connected to a line scanning driver 190, and the signal lines 184 are connected to a multiplexer 192. The gate lines 182 are supplied with control signals Von, Voff for turning on and off the TFTs 188 along the rows from the line scanning driver 190. The line scanning driver 190 comprises a plurality of switches SW1 for switching between the gate lines 182 and an address decoder 194 for outputting a selection signal for selecting one of the switches SW1 at a time. The address decoder 194 is supplied with an address signal from the cassette controller 168.

The signal lines 184 are supplied with electric charges stored by the pixels 180 through the TFTs 188 arranged in the columns. The electric charges supplied to the signal lines 184 are amplified by amplifiers 196 connected respectively to the signal lines 184. The amplifiers 196 are connected through respective sample and hold circuits 198 to the multiplexer 192. The multiplexer 192 comprises a plurality of switches SW2 for successively switching between the signal lines 184 and an address decoder 200 for outputting a selection signal for selecting one of the switches SW2 at a time. The address decoder 200 is supplied with an address signal from the cassette controller 168. The multiplexer 192 has an output terminal connected to an A/D converter 202. A radiographic image signal generated by the multiplexer 192 based on the electric charges from the sample and hold circuits 198 is converted by the A/D converter 202 into a digital image signal representing radiographic image information, which is supplied to the cassette controller 168.

The TFTs 188 which function as switching devices may be combined with another image capturing device such as a CMOS (Complementary Metal-Oxide Semiconductor) image sensor or the like. Alternatively, the TFTs 188 may be replaced with a CCD (Charge-Coupled Device) image sensor for shifting and transferring electric charges with shift pulses which correspond to gate signals in the TFTs.

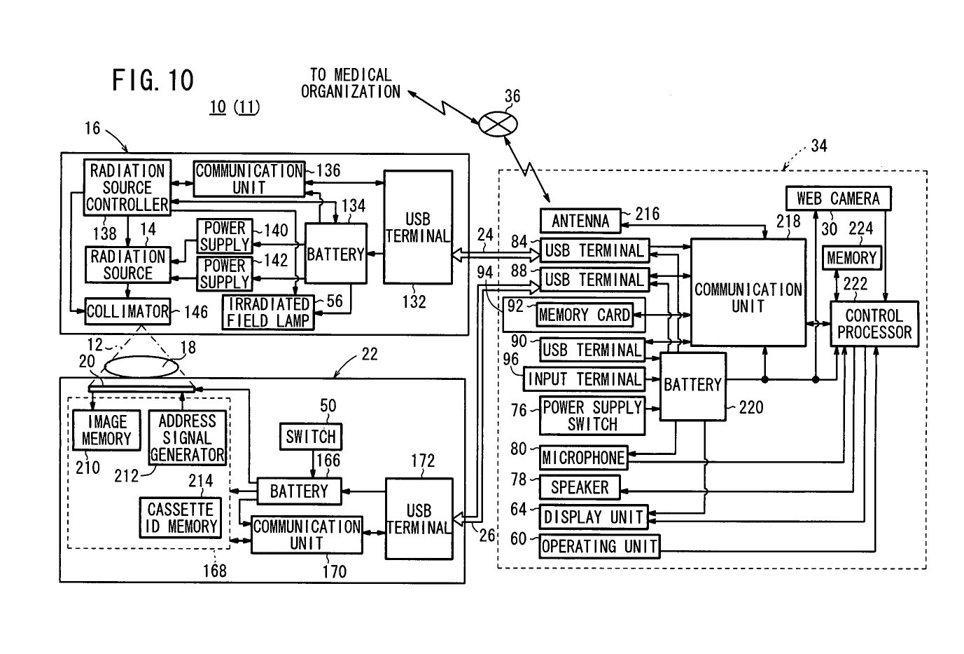

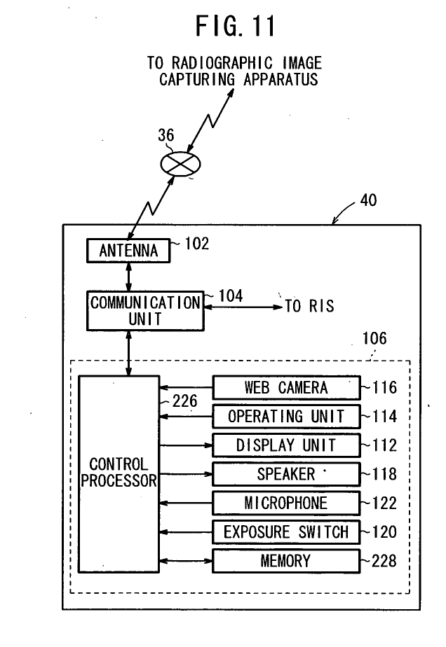

FIG. 10 shows in block form the radiographic image capturing apparatus 10, and FIG. 11 shows in block form the medical organization 40.

Those components of the radiographic image capturing apparatus 10 and the medical organization 40 which have not been described above with reference to FIGS. 1 through 9 will be described below with reference to FIGS. 10 and 11. Some of the components described with reference to FIGS. 1 through 9 will also be described in specific detail below with reference to FIGS. 10 and 11.

The cassette controller 168 of the cassette 22 comprises an image memory 210, an address signal generator 212, and a cassette ID memory 214.

The address signal generator 212 supplies address signals to the address decoder 194 of the line scanning driver 190 and the address decoder 200 of the multiplexer 192. The image memory 210 stores radiographic image information detected by the radiation detector 20. The cassette ID memory 214 stores cassette ID information for identifying the radiographic image capturing apparatus 10 or specifically, the cassette 22 thereof.

The cassette controller 168 sends the cassette ID information stored in the cassette ID memory 214 and the radiographic image information stored in the image memory 210 from the communication unit 170 to the mobile information terminal 34 via the USB terminal 172 and the USB cable 26.

The mobile information terminal 34 includes: a communication unit (controller communication unit, camera image communication unit) 218 which is capable of sending signals to and receiving signals from an external circuit via an antenna 216 by way of wireless communications, of sending signals to and receiving signals from external circuits via the USB terminals 84, 88, 90 by way of wired communications, and of sending signals to and receiving signals from the memory card 92 inserted in the card slot 94; a battery 220 for supplying electric power to various components of the mobile information terminal 34; a control processor 222 for performing various control sequences; and a memory 224 for storing camera image information, radiographic image information, etc.

When the operator 32 turns on the power supply switch 76, the battery 220 supplies electric power to the web camera 30, the speakers 78, the microphone 80, the communication unit 218, and the control processor 222. While the mobile information terminal 34, the radiation source device 16, and the cassette 22 are being electrically connected to each other by the USB cables 24, 26, the battery 220 can charge the batteries 134, 166 via the USB cables 24, 26. The battery 220 can be charged from an external circuit via the input terminal 96.

The control processor 222 comprises a CPU of the mobile information terminal 34 and carries out various control sequences by reading and executing programs stored in the memory 224.

Specifically, the control processor 222 stores camera image information captured by the web camera 30 and radiographic image information and cassette ID information received from the cassette 22 via the USB cable 26 and the communication unit 218 into the memory 224, displays a corresponding camera image and/or a corresponding radiographic image on the display unit 64, and sends the camera image information and/or the radiographic image information and the cassette ID information to the medical organization 40 via the communication unit 218, the antenna 216, and the network 36 by way of wireless communications. The control processor 222 also sends a sound signal representing the voice of the operator 32 or the voice of the subject 18 detected by the microphone 80 to the medical organization 40 via the communication unit 218, the antenna 216, and the network 36 by way of wireless communications.

The control processor 222 displays, on the display unit 64, a camera image of the doctor 38 captured by the web camera 116 and received from the medical organization 40 via the network 36, the antenna 216, and the communication unit 218, and outputs the voice of the doctor 38 from the speakers 78 based on a sound signal received from the medical organization 40. When the control processor 222 receives an exposure control signal from the medical organization 40, the control processor 222 generates a synchronization control signal depending on the received exposure control signal and sends the generated synchronization control signal to the radiation source device 16 and the cassette 22 via the USB cables 24, 26 thereby to synchronize the outputting of the radiation 12 from the radiation source 14 and the detection and conversion of the radiation 12 into the radiation image information by the radiation detector 20.

The console 106 also includes a memory 228 and a control processor 226 for performing various control sequences.

The control processor 226 comprises a CPU of the main body 108 and carries out various control sequences by reading out and executing programs stored in the memory 228.

Specifically, the control processor 226 stores camera image information captured by the web camera 116 into the memory 228, displays a corresponding camera image on the display unit 112, and sends the camera image information to the mobile information terminal 34 via the communication unit 104, the antenna 102, and the network 36 by way of wireless communications. The control processor 226 also sends a sound signal representing the voice of the doctor 38 detected by the microphone 122 to the mobile information terminal 34 via the communication unit 104, the antenna 102, and the network 36 by way of wireless communications.

The control processor 226 stores camera image information sent from the mobile information terminal 34 by way of wireless communications and/or radiographic image information and cassette ID information into the memory 228, and displays a camera image and/or a radiographic image on the display unit 112. The control processor 226 outputs the voice of the operator 32 or the voice of the subject 18 from the speaker 118 based on a sound signal sent from the mobile information terminal 34 by way of wireless communications.

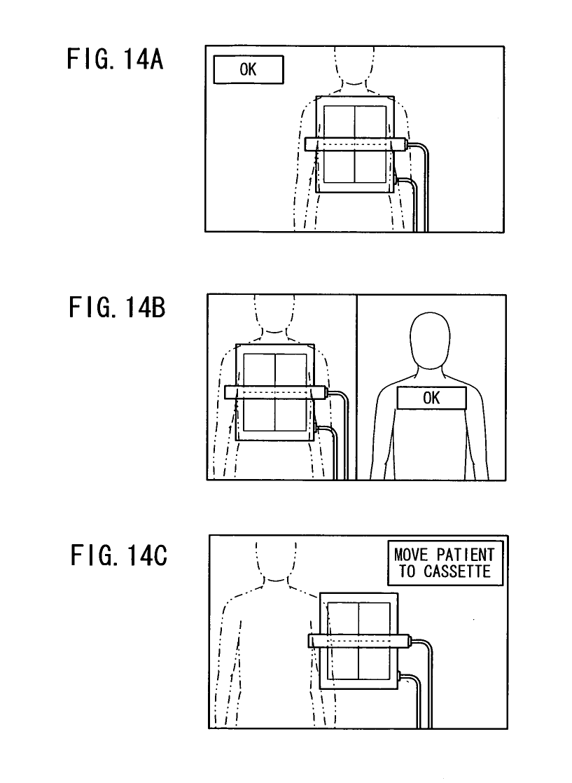

Before the radiation source 14 emits the radiation 12, i.e., during the preparatory procedure, if a body region of the subject 18 to be imaged is included in the outer frame of the guide lines 46 on a camera image captured by the web camera 30 and displayed on the display unit 112 (see FIGS. 14A and 14B), then the doctor 38 judges that an appropriate radiographic image of the body region of the subject 18 to be imaged can be acquired by applying the radiation 12 to the subject 18, and turns on the exposure switch 120. When the exposure switch 120 is turned on, the control processor 226 generates an exposure control signal for starting to emit the radiation 12 from the radiation source 14, and sends the generated exposure control signal to the mobile information terminal 34 via the communication unit 104, the antenna 102, and the network 36 by way of wireless communications.

However, before the radiation source 14 emits the radiation 12, if a body region of the subject 18 to be imaged is not included, or only a portion of the body region is included, in the outer frame of the guide lines 46 on a camera image captured by the web camera 30 and displayed on the display unit 112 (see FIG. 14C), then the doctor 38 judges that an appropriate radiographic image of the body region of the subject 18 to be imaged cannot be acquired by applying the radiation 12 to the subject 18. The doctor 38 does not turn on the exposure switch 120, but gives a voice instruction via the microphone 122 to change the position or attitude of the subject 18 until the body region to be imaged is included in the outer frame of the guide lines 46. When the control processor 226 receives a sound signal (instruction signal) from the microphone 122 based on the voice of the doctor 38, the control processor 226 goes not generate an exposure control signal.

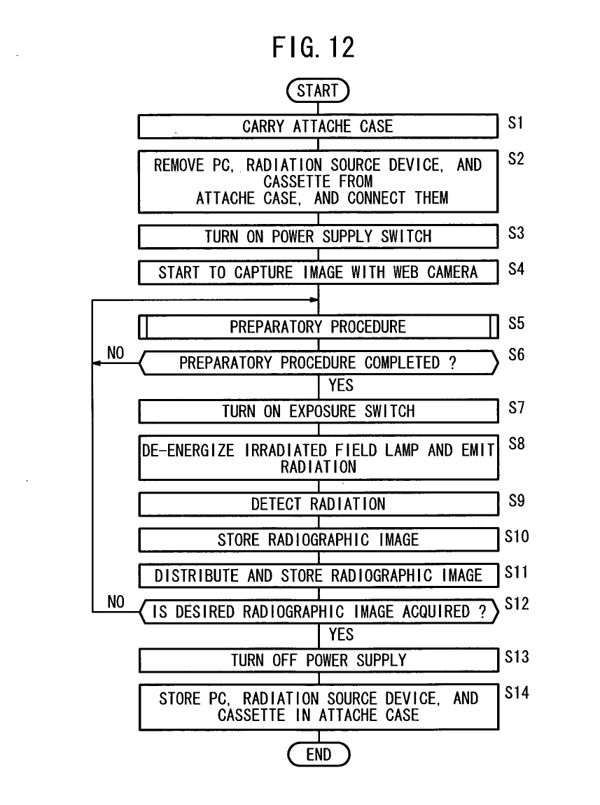

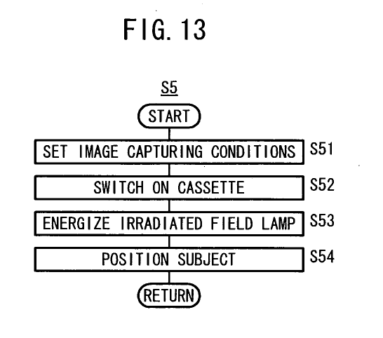

The radiographic image capturing apparatus 10 and the radiographic image capturing system 11 according to the present embodiment are basically constructed as described above. Operation of the radiographic image capturing apparatus 10 and the radiographic image capturing system 11 to carry out a radiographic image capturing method will be described below with reference to flowcharts shown in FIGS. 12 and 13.

In step S1 shown in FIG. 12, the operator 32 carries the attaché case 98 from the medical organization 40 where the doctor 38 is unable to see the patient 18 directly to a disaster site or a home receiving home-care services according to the directions from the doctor 38 who has the legal authority about the application of the radiation 12 to the subject 18.

In step S2 after the operator 32 has arrived at the disaster site or the home, the operator 32 removes the radiation source device 16, the cassette 22, the mobile information terminal 34, and the USB cables 24, 26 from the attaché case 98, connects the mobile information terminal 34 and the radiation source device 16 to each other with the USB cable 24, and connects the mobile information terminal 34 and the cassette 22 with the USB cable 26. The mobile information terminal 34 and the radiation source device 16 are electrically connected to each other by the USB cable 24, and the mobile information terminal 34 and the cassette 22 are electrically connected to each other by the USB cable 26. In step S2, the operator 32 places the mobile information terminal 34, the radiation source device 16, and the cassette 22 in the layout shown in FIGS. 1 through 4.

In step S3, the operator 32 turns the lid 66 away from the main body 62 about the shaft 68 and the hinges 70 to unfold the mobile information terminal 34 from the folded form until the operating unit 60 and the display unit 64 can be seen as shown in FIGS. 1 through 4. Thereafter, the operator 32 turns on the power supply switch 76 to activate the mobile information terminal 34.

When the power supply switch 76 is turned on, the battery 220 starts to supply electric power to the web camera 30, the display unit 64, the microphone 80, the communication unit 218, and the control processor 222, and also starts to charge the battery 134 of the radiation source device 16 and the battery 166 of the cassette 22 from the USB terminals 84, 88 via the USB cables 24, 26. When supplied with electric power from the battery 220, the web camera 30 starts to capture an image of the imaging area 28 and outputs captured image information to the control processor 222 in step S4.

When supplied with electric power from the battery 220, the control processor 222 reads out programs from the memory 224 and executes the programs to store the camera image information sent from the web camera 30 into the memory 224, display a corresponding camera image on the display unit 64, and sends the camera image information from the communication unit 218 via the antenna 216 to an external circuit by way of wireless communications.

The camera image information from the web camera 30 is sent via the network 36 to the medical organization 40 by way of wireless communications. The communication unit 104 of the medical organization 40 outputs the camera image information received via the antenna 102 to the control processor 226. The control processor 226 stores the camera image information into the memory 228 and displays a corresponding camera image on the display unit 112 by reading out programs stored in the memory 228 and executing the programs. By seeing the camera image displayed on the display unit 112, the doctor 38 can clearly recognize the positional relationship between the radiation source device 16, the subject 18, and the cassette 22 at the disaster site or the home.

In step S5, the operator 32 performs a preparatory procedure for making the radiographic image capturing apparatus 10 ready to capture a radiographic image of a body region of the subject 18 to be imaged (e.g., the chest of the subject 18).

FIG. 13 is a flowchart of the preparatory procedure in step S5. FIGS. 14A through 14C are views showing by way of example images displayed on the display unit 64 of the mobile information terminal 34 and the display unit 112 of the console 106 during the preparatory procedure.

In step S51 shown in FIG. 13, the operator 32 operates the operating unit 60 of the mobile information terminal 34 to register image capturing conditions (e.g., a tube voltage and a tube current of the radiation source 14, an exposure time of the radiation 12) including subject information of the subject 18 to be imaged. If a body region to be imaged and an image capturing method are known, then the operator 32 also registers them as image capturing conditions. The control processor 222 stores (registers) the entered image capturing conditions into the memory 224.

If the subject 18 to be imaged is known before the operator 32 goes to the disaster site or the home, then the operator 32 may operate the operating unit 60 of the mobile information terminal 34 at the medical organization 40 to which the operator 32 belongs to register the image capturing conditions.

Since the mobile information terminal 34 and the medical organization 40 can send signals to and receive signals from each other via the network 36 by way of wireless communications, as described above, the doctor 38 may operate the operating unit 114 of the console 106 to enter the image capturing conditions and send the entered image capturing conditions via the network 36 to the mobile information terminal 34 by way of wireless communications. Alternatively, the doctor 38 at the medical organization 40 may send image capturing conditions to be registered in the memory 224 via the network 36 by way of wireless communications, and the operator 32 may operate the operating unit 60 to register the image capturing conditions that have been sent from the doctor 38.

In step S52, the operator 32 turns on the switch 50 of the cassette 22. The battery 166 supplies electric power to the radiation detector 20, the cassette controller 168, and the communication unit 170, thereby activating the cassette 22 in its entirety. The cassette controller 168 sends an activation notice signal representing that the cassette 22 has been activated to the mobile information terminal 34 via the communication unit 170, the USB terminal 172, and the USB cable 26.

Based on the activation notice signal received via the USB cable 26, the USB terminal 88, and the communication unit 218, the control processor 222 sends an image-capture preparation command signal for image-capture preparations and the image capturing conditions registered in the memory 224 to the radiation source device 16 and the cassette 22 via the communication unit 218, the USB terminals 84, 88, and the USB cables 24, 26.

Since the battery 134 of the radiation source device 16 supplies electric power to the communication unit 136 and the radiation source controller 138 at all times, when the radiation source controller 138 receives the image-capture preparation command signal and the image capturing conditions via the USB cable 24, the USB terminal 132, and the communication unit 136, the radiation source controller 138 registers the image capturing conditions and controls the battery 134 to supply electric power to the irradiated field lamp 56. When the irradiated field lamp 56 is supplied with the electric power from the battery 134, the irradiated field lamp 56 emits the irradiation light 54. The irradiation light 54 is reflected by the mirror 144 to the collimator 146, and is output from the radiation source device 16 and applied to the irradiated surface 44 of the cassette 22 in step S53.

If the imaging distance is adjusted to the SID, then the irradiated field that is displayed on the irradiated surface 44 by the application of the irradiation light 54 is substantially in agreement with the outer frame of the guide lines 46. If the position of the irradiated field, i.e., the range irradiated by the irradiation light 54, is not in agreement with the position of the outer frame of the guide lines 46 or if the size of the irradiated field is not in agreement with the size of the outer frame of the guide lines 46, then the operator 32 adjusts the positional relationship between the radiation source device 16 and the cassette 22 in order to equalize the imaging distance with the SID.

The image-capture preparation command signal and the image capturing conditions are also sent to the cassette 22 to enable the cassette controller 168 to recognize that the radiographic image capturing apparatus 10 has been readied for capturing radiographic images, and registers the image capturing conditions into the cassette ID memory 214. It has been described above that the radiation detector 20 is activated when the switch 50 is turned on. However, when the cassette controller 168 receives the image-capture preparation command signal, the battery 166 may supply electric power (bias voltage Vb) to the radiation detector 20 to activate the radiation detector 20.

In step S54 after the imaging distance is adjusted to the SID to bring the irradiated field into agreement with the outer frame of the guide lines 46, the operator 32 puts the subject 18 in front of the irradiated surface 44 of the cassette 22 and positions the subject 18 to bring the body region of the subject 18 to be imaged into the outer frame of the guide lines 46.

The web camera 30 captures a camera image of the imaging area 28 which covers the body region of the subject 18 to be imaged, the radiation source device 16, and the irradiated surface 44 of the cassette 22, and the display unit 64 of the mobile information terminal 34 displays the camera image captured by the web camera 30. The operator 32 can position the subject 18 to place the body region to be imaged within the outer frame of the guide lines 46 on the camera image by instructing the subject 18 to move while seeing, i.e., monitoring, the camera image displayed on the display unit 64.

The camera image captured by the web camera 30 is sent, i.e., distributed, from the control processor 222 to the medical organization 40 via the antenna 216 and the network 36. The communication unit 104 of the medical organization 40 receives the camera image via the antenna 102 and outputs the received camera image to the console 106. The control processor 226 of the console 106 stores the camera image into the memory 228 and displays the camera image on the display unit 112.

In step S6 shown in FIG. 12, the doctor 38 in the medical organization 40 sees the camera image displayed on the display unit 112 and determines whether the preparatory procedure is completed or not, i.e., whether the body region of the subject 18 to be imaged is included within the outer frame of the guide lines 46 or not.

If the camera image displayed on the display units 64, 112 shows that the body region (chest) of the subject 18 to be imaged is included within the outer frame of the guide lines 46 as shown in FIG. 14A, then the doctor 38 judges that it is possible to obtain an appropriate radiographic image of the subject 18 by imaging the subject 18 according to the positional relationship between the body region to be imaged and the guide lines 46 that are presently displayed on the display units 64, 112 (step S6: YES), and talks into the microphone 122 or operates the operating unit 114 to indicate that the preparatory procedure is completed.

The control processor 226 of the console 106 sends a signal based on the voice detected by the microphone 122 or the input applied to the operating unit 114 to the mobile information terminal 34 via the communication unit 104, the antenna 102, and the network 36 by way of wireless communications. Based on the signal received via the antenna 216 and the communication unit 218, the control processor 222 of the mobile information terminal 34 displays a visual message “OK” indicating that the preparatory procedure is completed on the display unit 64, as shown in FIG. 14A, or outputs a sound message “OK” from the speakers 78. Therefore, the operator 32 knows that the preparatory procedure is completed by seeing the visual message “OK” displayed on the display unit 64 or hearing the sound message “OK” from the speakers 78.

The web camera 116 of the console 106 captures a camera image of the doctor 38, and the control processor 226 sends the camera image captured by the web camera 116 to the mobile information terminal 34 via the communication unit 104, the antenna 102, and the network 36. The control processor 222 may display both the camera image captured by the web camera 30, i.e., an image indicating the positioning of the subject 18, and the camera image captured by the web camera 116, i.e., an image of the doctor 38, on the display unit 64, with the visual message “OK” being displayed over the camera image captured by the web camera 116, as shown in FIG. 14B.

Since the image of the doctor 38 is displayed on the display unit 64, the operator 32 can see the image displayed on the display unit 64 and immediately understand that the doctor 38 has confirmed the camera image captured by the web camera 30 and has approved of image capturing at the present position of the subject 18, i.e., has indicated the completion of the preparatory procedure.

In addition to the displayed image shown in FIG. 14A or 14B, the voice of the doctor 38 which is detected by the microphone 122 may be output from the speakers 78. Furthermore, the display unit 112 may display the same image as the image displayed on the display unit 64 as shown in FIG. 14A or 14B.

If the body region of the subject 18 to be imaged is not included, or only a portion of the body region is included, in the outer frame of the guide lines 46 on the camera image captured by the web camera 30 and displayed on the display unit 112 (see FIG. 14C) in step S6, then the doctor 38 judges that a desired radiographic image of the subject 18 cannot be acquired by imaging the subject 18 according to the positional relationship between the body region to be imaged and the guide lines 46 that are presently displayed on the display units 64, 112 (step S6: NO), and talks into the microphone 122 or operates the operating unit 114 to indicate to the operator 32 that the present positional relationship between the body region to be imaged and the guide lines 46 is inappropriate and the preparatory procedure is to be performed again.

The control processor 226 of the console 106 sends a command signal based on the voice detected by the microphone 122 or the input applied to the operating unit 114 to the mobile information terminal 34 via the communication unit 104, the antenna 102, and the network 36 by way of wireless communications. Based on the command signal received via the antenna 216 and the communication unit 218, the control processor 222 of the mobile information terminal 34 displays a visual message “MOVE PATIENT TO CASSETTE”, or the like, indicating that the preparatory procedure is to be performed again on the display unit 64, as shown in FIG. 14C, or outputs a corresponding sound message from the speakers 78. Therefore, the operator 32 immediately understands that the operator 32 is instructed to perform the preparatory procedure again by seeing the visual message displayed on the display unit 64 or hearing the sound message from the speakers 78, and positions the subject 18 again according to the visual message or the sound message.

When the preparatory procedure in step S5 is to be performed again, since the processing in steps S51 through S53 has already been carried out, the operator 32 only positions the subject 18 in step S54.

In step S7, providing the preparatory procedure is completed (step S6: YES), the doctor 38 turns on the exposure switch 120. The control processor 226 generates an exposure control signal for starting to emit the radiation 12 from the radiation source 14, and sends the generated exposure control signal to the mobile information terminal 34 via the communication unit 104, the antenna 102, and the network 36 by way of wireless communications.

When the control processor 222 receives the exposure control signal via the antenna 216 and the communication unit 218, the control processor 222 generates a synchronization control signal to synchronize the outputting from the radiation source 14 and the detection and conversion of the radiation 12 by the radiation detector 20 into the radiation image information for thereby capturing a radiographic image of the subject 18, and sends the generated synchronization control signal to the radiation source device 16 and the cassette 22 via the communication unit 218, the USB terminals 84, 88, and the USB cables 24, 26.

In step S8, when the radiation source controller 138 receives the synchronization control signal via the USB terminal 132 and the communication unit 136, the radiation source controller 138 stops supplying the electric power from the battery 134 to the irradiated field lamp 56, thereby stopping the application of the irradiation light 54 from the irradiated field lamp 56, and controls the radiation source 14 to applying a radiation 12 of a predetermined dose to the subject 18 according to the image capturing conditions registered in the radiation source controller 138.

In the radiation source 14, the rotating mechanism 148 is controlled by the radiation source controller 138 to rotate the rotational shaft 150 and the rotary anode 152. The power supply 142 applies a negative voltage to the field-emission-type electron source 158 based on the electric power supplied from the battery 134, and the power supply 140 applies a voltage between the rotary anode 152 and the cathode 156 based on the electric power supplied from the battery 134. The field-emission-type electron source 158 emits electrons which are accelerated by the voltage applied between the rotary anode 152 and the cathode 156 and bombard the target layer 154. The surface of the target layer 154 which is bombarded with the electrons emits from the focused point 160 the radiation 12 whose intensity depends on the applied electrons.

The radiation 12 passes through the mirror 144 and is constricted in its irradiation area by the collimator 146 and output from the radiation source device 16 and applied to the subject 18. The radiation 12 is applied to and passes through the subject 18 for a given irradiation time depending on the image capturing conditions, and reaches the radiation detector 20 in the cassette 22.

In step S9, since the radiation detector 20 is of the indirect conversion type, the scintillator of the radiation detector 20 emits visible light having an intensity depending on the intensity of the radiation 12, and the pixels 180 of the photoelectric conversion layer 186 converts the visible light into electric charges and store the electric charges. The electric charges stored by the pixels 180, which are representative of a radiographic image of the subject 18, are read from the pixels 180 according to address signals which are supplied from the address signal generator 212 of the cassette controller 168 to the line scanning driver 190 and the multiplexer 192.

Specifically, in response to the address signal supplied from the address signal generator 212, the address decoder 194 of the line scanning driver 190 outputs a selection signal to select one of the switches SW1, which supplies the control signal Von to the gates of the TFTs 188 connected to the gate line 182 corresponding to the selected switch SW1. In response to the address signal supplied from the address signal generator 212, the address decoder 200 of the multiplexer 192 outputs a selection signal to successively turn on the switches SW2 to switch between the signal lines 184 for thereby reading out the electric charges stored in the pixels 180 connected to the selected gate line 182, through the signal lines 184.

The electric charges read out from the pixels 180 connected to the selected gate line 182 are amplified by the respective amplifiers 196, sampled by the sample and hold circuits 198, and supplied to the multiplexer 192. Based on the supplied electric charges, the multiplexer 192 generates and supplies a radiographic image signal to the A/D converter 202, which converts the radiographic image signal into a digital signal. The digital signal which represents the radiographic image information is temporally stored in the image memory 210 of the cassette controller 168 in step S10.

Similarly, the address decoder 194 of the line scanning driver 190 successively turns on the switches SW1 to switch between the gate lines 182 according to the address signal supplied from the address signal generator 212. The electric charges stored in the pixels 180 connected to the successively selected gate lines 182 are read through the signal lines 184, and processed by the multiplexer 192 and the A/D converter 202 into a digital signal, which is stored in the image memory 210 of the cassette controller 168 in step S10.

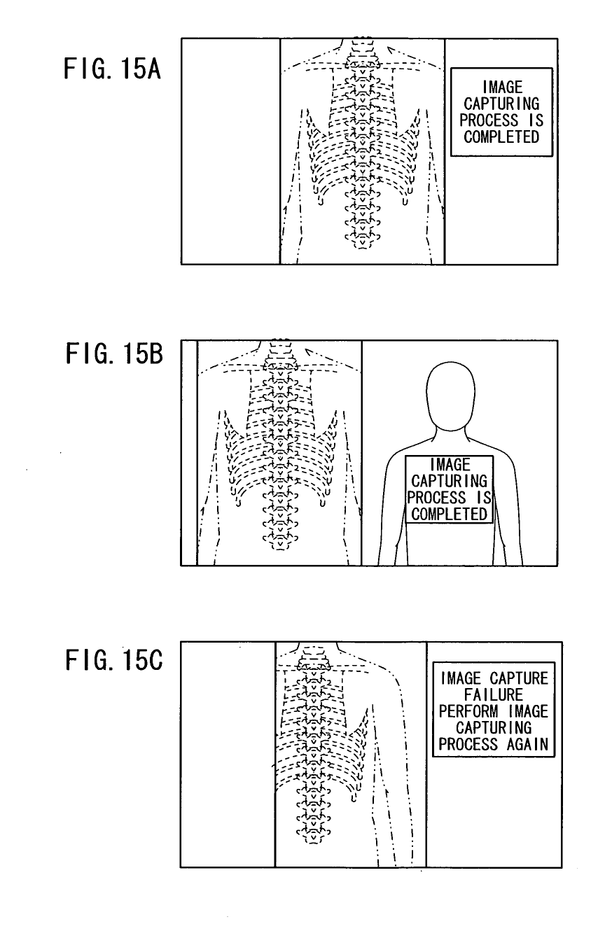

The radiographic image information represented by the digital signal stored in the image memory 210 is transmitted together with the cassette ID information stored in the cassette ID memory 214 to the mobile information terminal 34 via the communication unit 170, the USB terminal 172, and the USB cable 26 by way of wired communications. The control processor 222 of the mobile information terminal 34 stores the radiographic image information and the cassette ID information received via the USB terminal 88 and the communication unit 218 into the memory 224, and displays a corresponding radiographic image on the display unit 64 in step S11 (see FIG. 15A).

The control processor 222 also sends the radiographic image information and the cassette ID information to the medical organization 40 via the communication unit 218, the antenna 216, and the network 36 by way of wireless communications. In the medical organization 40, the communication unit 104 outputs the radiographic image information and the cassette ID information received via the antenna 102 to the control processor 226. The control processor 226 stores the radiographic image information and the cassette ID information into the memory 228, and displays a corresponding radiographic image on the display unit 112 (see FIG. 15A).

In step S12, the doctor 38 sees the radiographic image of the subject 18 displayed on the display unit 112 and determines whether the displayed radiographic image is appropriate or not.

For example, if the radiographic image displayed on the display units 64, 112 includes the body region (chest) of the subject 18 to be imaged as shown in FIG. 15A, then the doctor 38 judges that the process of capturing a radiographic image of the body region to be imaged is completed (step S21: YES), and talks into the microphone 122 or operates the operating unit 114 to indicate to the operator 32 that the image capturing process is completed.

The control processor 226 of the console 106 sends a signal based on the voice detected by the microphone 122 or the input applied to the operating unit 114 to the mobile information terminal 34 via the communication unit 104, the antenna 102, and the network 36 by way of wireless communications. Based on the signal received via the antenna 216 and the communication unit 218, the control processor 222 of the mobile information terminal 34 displays a visual message “IMAGE CAPTURING PROCESS IS COMPLETED” indicating that the image capturing process is completed on the display unit 64, as shown in FIG. 15A, or outputs a corresponding sound message from the speakers 78. Therefore, the operator 32 knows that the image capturing process is completed by seeing the visual message displayed on the display unit 64 or hearing the sound message from the speakers 78.

The control processor 222 may display both the radiographic image and the camera image captured by the web camera 116, i.e., an image of the doctor 38, on the display unit 64, with the visual message “IMAGE CAPTURING PROCESS IS COMPLETED” being displayed over the camera image captured by the web camera 116, as shown in FIG. 15B, as in the case shown in FIG. 14B.

Since the image of the doctor 38 is displayed along with the image on the display unit 64, the operator 32 can immediately understand that the doctor 38 has indicated the completion of the image capturing process.

In addition to the displayed image shown in FIG. 15A or 15B, the voice of the doctor 38 which is detected by the microphone 122 may be output from the speakers 78. Furthermore, the display unit 112 may display the same image as the image displayed on the display unit 64 as shown in FIG. 15A or 15B.

If the body region of the subject 18 to be imaged is not included, or only a portion of the body region is included, in the radiographic image displayed on the display unit 112 (see FIG. 15C) in step S12, then the doctor 38 judges that an appropriate radiographic image has not been acquired and the image capturing process needs to be performed again (step S12: NO), and talks into the microphone 122 or operates the operating unit 114 to indicate to the operator 32 that the image capturing process is to be performed again.

The control processor 226 of the console 106 sends a signal based on the voice detected by the microphone 122 or the input applied to the operating unit 114 to the mobile information terminal 34 via the communication unit 104, the antenna 102, and the network 36 by way of wireless communications. Based on the signal received via the antenna 216 and the communication unit 218, the control processor 222 of the mobile information terminal 34 displays a visual message “IMAGE CAPTURE FAILURE, PERFORM IMAGE CAPTURING PROCESS AGAIN” indicating that the image capturing process is to be performed again on the display unit 64, as shown in FIG. 15C, or outputs a corresponding sound message from the speakers 78. Therefore, the operator 32 recognizes that the image capturing process is to be performed again by seeing the visual message displayed on the display unit 64 or hearing the sound message from the speakers 78, and performs the preparatory procedure again according to instructions in step S5.

In step S13 after the image capturing process completed, the operator 32 operates the operating unit 60 or presses the power supply switch 76 to shut down the mobile information terminal 34. The battery 220 stops supplying electric power to various components of the mobile information terminal 34, and also stops charging the batteries 134, 166 via the USB cables 24, 26. The radiation source controller 138 detects when the battery 134 stops being charged, and causes the battery 134 from supplying electric power to various components of the radiation source device 16. The operator 32 also presses the switch 50 to shut down the cassette 22. The battery 166 now stops supplying electric power to various components of the cassette 22.

Then, the operator 32 turns the lid 66 toward the main body 62 about the shaft 68 and the hinges 70 until the teeth 72 fit into the recesses 74 when the mobile information terminal 34 is folded. The operator 32 detaches the USB cables 24, 26 from the radiation source device 16, the cassette 22, and the mobile information terminal 34, electrically disconnecting the mobile information terminal 34 from the radiation source device 16 and also electrically disconnecting the mobile information terminal 34 from the cassette 22. Thereafter, the operator 32 places the radiation source device 16, the cassette 22, the mobile information terminal 34, and the USB cables 24, 26 into the attaché case 98 in step S14. The operator 32 then brings the attaché case 98 back to the medical organization 40 to which the operator 32 belongs.

In the medical organization 40, the radiographic image information stored in the memory 224 of the radiographic image capturing apparatus 10 which the operator 32 has brought back is sent to the RIS of an in-hospital network or the console 106 via the communication unit 218 and the antenna 216 by way of wireless communications or via the USB terminals 84, 88, 90 by way of wired communications. Alternatively, the radiographic image information stored in the memory 224 of the radiographic image capturing apparatus 10 is saved in the memory card 92, which is then removed from the card slot 94 and connected to the RIS or the console 106. The medical organization 40 is now able to analyze the radiographic image information in detail for interpretation and diagnosis.

As described above, since the mobile information terminal 34 sends the radiographic image information, etc. via the network 36 to the medical organization 40 while the radiographic image capturing apparatus 10 is placed at the disaster site or the home, the medical organization 40 may analyze the transmitted radiographic image information in detail for interpretation and diagnosis.

With the radiographic image capturing apparatus 10, the radiographic image capturing system 11, and the radiographic image capturing method according to the present embodiment, as described above, the web camera 30 captures a camera image of at least the cassette 22, i.e., the guide lines 46 corresponding to the radiation detector 20 housed in the cassette 22 at the disaster site or the home, and the communication unit 218 sends the camera image captured by the web camera 30 via the network 36 to the communication unit 104 of the medical organization 40.

Based on the camera image received by the communication unit 104, the doctor (or the radiological technician) 38 waiting in the remote medical organization 40 where the doctor 38 is unable to see the subject 18 directly can instruct the operator 32 at the disaster site or the home to capture a radiographic image of the subject 18 in real time. Consequently, it is possible to capture a radiographic image of the subject 18 even though the doctor 38 does not directly go to the disaster site or the home, or in other words, even though the doctor 38 does not accompany the operator 32 who is not a qualified medical radiological technician, i.e., who does not have the legal authority about the application of the radiation 12 to the subject 18.

The outer frame of the guide lines 46 is aligned with the irradiated field which is irradiated with the radiation 12 at the time the imaging distance is set to the SID, and the web camera 30 captures a camera image of the outer frame of the guide lines 46. The doctor 38 confirms the camera image captured by the web camera 30, and if the body region of the subject 18 to be imaged is included in the outer frame of the guide lines 46, i.e., if the body region of the subject 18 to be imaged is displayed inwardly of the outer frame of the guide lines 46, the doctor 38 can judge that an appropriate radiographic image of the subject 18 can be acquired by applying the radiation 12 to the subject 18 thus positioned. If the body region of the subject 18 to be imaged is not included in the outer frame of the guide lines 46 or only a portion of the body region of the subject 18 to be imaged is included in the outer frame of the guide lines 46, then the doctor 38 can judge that an appropriate radiographic image of the subject 18 cannot be acquired by applying the radiation 12 to the subject 18 thus positioned.

As described above, the web camera 30 captures a camera image of the guide lines 46, and the doctor 38 sees, i.e., monitors, the camera image captured by the web camera 30 to determine whether the body region of the subject 18 to be imaged is included in the outer frame of the guide lines 46 or not and hence to determine whether an appropriate radiographic image of the subject 18 can be acquired or not. As a result, even if the doctor 38 is unable to see the subject 18 and the operator 32 directly, the doctor 38 is able to appropriately instruct the operator 32 at the site to perform the preparatory procedure.

The web camera 30 is disposed on the upper surface of the lid 66 of the mobile information terminal 34 and integrally combined with the mobile information terminal 34. As the web camera 30 captures a camera image of the radiation source device 16, the subject 18, and the cassette 22 including the guide lines 46 in the layout shown in FIGS. 1 through 4, it is possible to reliably obtain a camera image including the guide lines 46.

The operator 32 gives directions to the subject 18 while operating the mobile information terminal 34 to position the subject 18 with respect to the guide lines 46. Therefore, even if the radiation source 14 applies the radiation 12 to the subject 18 while the operator 32 is operating the mobile information terminal 34, the operator 32 is reliably prevented from being exposed to the radiation 12.

The communication unit 218 of the mobile information terminal 34 which incorporates the web camera 30 sends the camera image captured by the web camera 30 to the medical organization 40 via the antenna 216 and the network 36. Accordingly, the camera image captured by the web camera 30 is reliably sent to the medical organization 40.

The control processor 222 of the mobile information terminal 34 generates a synchronization control signal to synchronize the outputting of the radiation 12 from the radiation source 14 and the conversion by the radiation detector 20 from the radiation 12 into the radiation image information, and the communication unit 218 sends the synchronization control signal to the communication unit 136 of the radiation source device 16 and the communication unit 170 of the cassette 22. Consequently, the radiation source 14 and the radiation detector 20 are reliably synchronized in time with each other at the time a radiographic image of the subject 18 is captured.

The mobile information terminal 34, the radiation source device 16, and the cassette 22 are electrically connected to each other by the USB cables 24, 26. Therefore, the battery 220 of the mobile information terminal 34 can reliably charge the battery 134 of the radiation source device 16 and the battery 166 of the cassette 22, and signals can reliably be sent and received between the mobile information terminal 34, the radiation source device 16, and the cassette 22. Specifically, the mobile information terminal 34 can reliably send the synchronization control signal and the image capturing conditions to the radiation source device 16 and the cassette 22, and the cassette 22 can reliably send the radiation image information to the mobile information terminal 34.

Moreover, inasmuch as the camera image captured by the web camera 30 and the radiation image information are sent from the mobile information terminal 34 via the network 36 to the medical organization 40 by way of wireless communications, the doctor 38 in the medical organization 40 can give appropriate directions to the operator 32 and the subject 18 at the site by seeing the camera image and the radiographic image that are displayed on the display unit 112 of the console 106.

The console 106 has the exposure switch 120 for controlling the radiation source 14 to start to emit the radiation 12. When the doctor 38 turns on the exposure switch 120 based on the camera image displayed on the display unit 112, the control processor 226 of the console 106 generates an exposure control signal for starting to emit the radiation 12 from the radiation source 14, and sends the generated exposure control signal to the mobile information terminal 34 via the communication unit 104 and the network 36. The control processor 222 of the mobile information terminal 34 generates a synchronization control signal depending on the exposure control signal received by the communication unit 218 and sends the generated synchronization control signal to the radiation source device 16 and the cassette 22.

Consequently, the doctor 38 can perform the image capturing process in the medical organization 40 where the doctor 38 cannot see the subject 18 directly in real time while monitoring the subject 18, without going to the disaster site or the home receiving home-care services.

Specifically, when the preparatory procedure is completed, if the body region of the subject 18 to be imaged is included in the outer frame of the guide lines 46 on the camera image captured by the web camera 30, then the doctor 38 turns on the exposure switch 120 to start capturing a radiographic image of the subject 18. If the body region of the subject 18 to be imaged is not included, or only a portion of the body region to be imaged is included, in the outer frame of the guide lines 46 on the camera image captured by the web camera 30, the doctor 38 does not turn on the exposure switch 120, and instructs the operator 32 to perform the preparatory procedure again.

Accordingly, the image capturing process can simply and reliably be performed under remote control from the medical organization 40.

As the doctor 38 directs the operator 32 at the site with visual messages displayed on the display unit 64 and voices output from the speakers 78, the directions can accurately and efficiently be transmitted from the doctor 38 to the operator 32 at the site.

If the camera image output from the web camera 30 comprises a moving image or still images captured intermittently at given time intervals, then the doctor 38 can send timely directions to the operator 32 at the site. If the camera image output from the web camera 30 comprises, a still image captured at a certain time in the preparatory procedure, then the doctor 38 can determine whether the subject 18 is in a position suitable for capturing a radiographic image thereof or not.

As the web camera 30 is an optical camera, it can produce a camera image which can easily be seen by the doctor 38 when displayed.

It has been described above that the directions of the doctor 38 are transmitted to the operator 32 by both the visual message displayed on the display unit 64 and the sound message output from the speakers 78. However, the directions of the doctor 38 may be transmitted to the operator 32 by either the visual message displayed on the display unit 64 or the sound message output from the speakers 78.

It has also been described above that the doctor 38 gives the directions to the operator 32 and the operator 32 positions the subject 18 according to the directions. However, since the subject 18 also hears the sound message output from the speakers 78, the doctor 38 may directly transmit the directions to the subject 18 to position the subject 18. Alternatively, before the subject 18 positions itself, the subject 18 may confirm the visual message displayed on the display unit 64 and then position itself with respect to the guide lines 46 as per the directions.

It has further been described above that the mobile information terminal 34 sends a synchronization control signal via the USB cables 24, 26 to the radiation source device 16 and the cassette 22. However, the control processor 226 of the console 106 may generate a synchronization control signal and send the generated synchronization control signal via the network 36, the mobile information terminal 34, and the USB cables 24, 26 to the radiation source device 16 and the cassette 22.

Moreover, instead of activating the cassette 22 by turning on the switch 50, the operator 32 may operate the operating unit 60 or the doctor 38 may operate the operating unit 114 to activate the cassette 22.

It has been described above that the battery 220 charges the batteries 134, 166 while the mobile information terminal 34 is electrically connected to the radiation source device 16 and the cassette 22 by the USB cables 24, 26. However, the batteries 134, 166 may be charged to a level high enough to capture at least a desired number of radiographic images of the subject 18. Therefore, the desired number of radiographic images of the subject 18 can reliably be captured in the image capturing process.

Alternatively, the batteries 134, 166 may be charged only in a period of time from step S3 through step S7 shown in FIG. 12. According to this alternative, as the batteries 134, 166 are not charged when a radiographic image is captured and corresponding radiographic image information is transmitted, the electric charges generated by the pixels 180 are prevented from suffering noises caused by battery charging when a radiographic image of the subject 18 is captured or the radiographic image information is prevented from suffering noises caused by battery charging when the radiographic image information is transmitted.

In the above description, the image capturing process is initiated when the exposure switch 120 is turned on. However, inasmuch as the image capturing process may be started according to directions from the doctor 38, an exposure button (exposure switch) may be displayed on a touch-panel screen of the display unit 112 and may be touched by the doctor 38 to start the image capturing process, or one of the buttons of the operating unit 114 may be pressed dedicated to functioning as an exposure switch and the doctor 38 presses the button to start the image capturing process.

The cassette 22 is illustrated as having a rectangular housing shape. However, the cassette 22 may be in the form of a flexible sheet in a portion thereof which includes the radiation detector 20. The cassette 22 in the form of a flexible sheet makes it possible to reduce the entire radiographic image capturing apparatus 10 in size and weight because the flexible sheet can be coiled into a roll.

During the image capturing process, the radiation source device 16 and the cassette 22 are securely fixed in position by holders, not shown. However, the operator 32 may hold the radiation source device 16 by hand at least during the image capturing process.

In the above description, the battery 220 charges the batteries 134, 166. However, one of the three batteries may be regarded as a power supply for the entire radiographic image capturing apparatus 10, and may charge the other two batteries.

It has been described above that the camera image captured by the web camera 30 is sent from the communication unit 218 of the mobile information terminal 34 via the network 36 to the communication unit 104 of the medical organization 40. However, the present embodiment is not limited to such an arrangement.

The communication unit 136 of the radiation source device 16 and the communication unit 170 of the cassette 22 may have a function to communicate with the communication unit 104 via the network 36, and may send the camera image.

If the communication units 136, 170 have such communication capability, then the communication unit 170 is able to send the radiation image information directly to the communication unit 104 via the network 36 or to send the radiation image information to the communication unit 104 via the communication unit 136 and the network 36.

It is also possible to send and receive all signals between the radiographic image capturing apparatus 10 and the medical organization 40, between the communication unit 136 and the communication unit 104 or between the communication unit 170 and the communication unit 104.

In the above description, signals are sent and received between the radiographic image capturing apparatus 10 and the medical organization 40 via the network 36 by way of wireless communications. The present embodiment is not limited to such an arrangement, but signals may be sent and received by way of other forms of communications.

For example, signals are sent and received between the radiographic image capturing apparatus 10 and the medical organization 40 via the network 36 by way of wired communications. Specifically, if the network 36 includes a repeater (a repeating device), then signals may be sent and received by way of wired communications (or wireless communications) up to the repeater, and may be sent and received by way of wireless communications (or wired communications) beyond the repeater.

Another mobile terminal such as a mobile phone or the like may be electrically connected to the mobile information terminal 34, and may send signals to and receive signals from the medical organization 40 or to and from the radiation source device 16 and the cassette 22 using the communication function of the other mobile terminal. In this case, the communication unit of the other mobile terminal functions as the communication unit 218.

The present embodiment is applicable to the acquisition of radiographic images using a light readout type radiation detector. The light readout type radiation detector operates as follows: When a radiation is applied to a matrix of solid-state detecting devices, the solid-state detecting devices store an electrostatic latent image depending on the dose of the applied radiation. For reading out the stored electrostatic latent image, reading light is applied to the solid-state detecting devices to cause the solid-state detecting devices to generate an electric current representing radiation image information. When erasing light is applied to the radiation detector, radiographic image information representing a residual electrostatic latent image is erased from the radiation detector, which can thus be reused (see Japanese Laid-Open Patent Publication No. 2000-105297).

To prevent the radiographic image capturing apparatus 10 from being contaminated with blood and bacteria, the entire radiographic image capturing apparatus 10 may be of a water-resistant and hermetically sealed structure, and may be sterilized and cleaned when necessary so that it can be used repeatedly.

In the present embodiment, as shown in FIG. 16, a cradle 230 for charging the batteries 134, 166, 220 (see FIG. 10) is positioned at a desired location in the medical organization 40.

The cradle 230 is electrically connected to the mobile information terminal 34 by a USB cable 234 having connectors 236, 238, electrically connected to the radiation source device 16 by the USB cable 24, and electrically connected to the cassette 22 by the USB cable 26.

The cradle 230 may not only be able to charge the batteries 134, 166, 220, but also have a wireless or wired communication function to send and receive necessary information to and from the console 106 and the RIS of the medical organization 40. The information that is sent from the cradle 230 may include radiation image information recorded in the radiographic image capturing apparatus 10 that is connected to the cradle 230.

The cradle 230 has a display unit 232 for displaying the charged state of the radiographic image capturing apparatus 10 connected to the cradle 230 and necessary information including radiographic image information acquired from the radiographic image capturing apparatus 10.

A plurality of cradles 230 may be connected to a network, and charged states of radiographic image capturing apparatus 10 that are connected to the cradles 230 may be retrieved through the network, so that the user can confirm the locations of any radiographic image capturing apparatus 10 which are sufficiently charged, based on the retrieved charged states.

The radiographic image capturing apparatus 10 according to the present embodiment has been illustrated as being used to capture radiographic images at disaster sites and homes receiving home-care services. However, the radiographic image capturing apparatus 10 according to the present embodiment is not limited to the capture of radiographic images at disaster sites and homes receiving home-care services, but may be mounted on medical examination cars for capturing radiographic images for use in medical examinations or may be used doctor's rounds in the medical organization 40. Furthermore, the radiographic image capturing apparatus 10 according to the present embodiment is not limited to use in the capture of radiographic images in the medical field, but is also applicable to the capture of radiographic images in various nondestructive tests, for example.

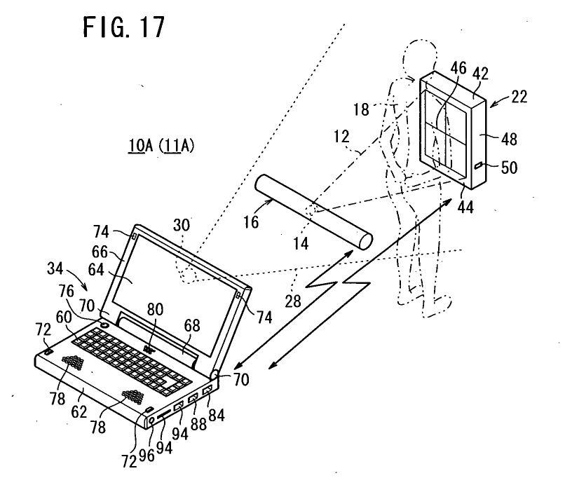

Modifications ranging from first through eleventh modifications of the above embodiment will be described below with reference to FIGS. 17 through 37B.

Those parts of the modifications which are identical to those of the radiographic image capturing apparatus 10 shown in FIGS. 1 through 16 are denoted by identical reference characters, and will not be described in detail below. In FIGS. 17 through 37B, the network 36 and the medical organization 40 are omitted from illustration.

As shown in FIG. 17, a radiographic image capturing apparatus 10A and a radiographic image capturing system 11A according to a first modification are different from the radiographic image capturing apparatus 10 and the radiographic image capturing system 11 shown in FIGS. 1 through 16 in that signals are sent and received between the mobile information terminal 34, the radiation source device 16, and the cassette 22 by way of wireless communications.

The mobile information terminal 34, the radiation source device 16, and the cassette 22 are wirelessly connected to each other within one link. Therefore, no cables are required to send and receive signals between them, and hence no obstacles are present to the operator 32 working on the radiographic image capturing apparatus 10. The operator 32 is thus able to work efficiently on the radiographic image capturing apparatus 10A. In addition, as no cables are required, the number of parts of the radiographic image capturing apparatus 10A is reduced, making it easy to assemble the radiographic image capturing apparatus 10A on site.

Furthermore, as the mobile information terminal 34, the radiation source device 16, and the cassette 22 are present within one link, either one of the communication units 136, 170, 218 (see FIG. 10) may be used to send and receive signals representative of camera images and radiographic images to and from the communication unit 104 of the medical organization 40 (see FIG. 1).

According to the first modification, signals may be sent and received by way of optical wireless communications using infrared radiation or the like.

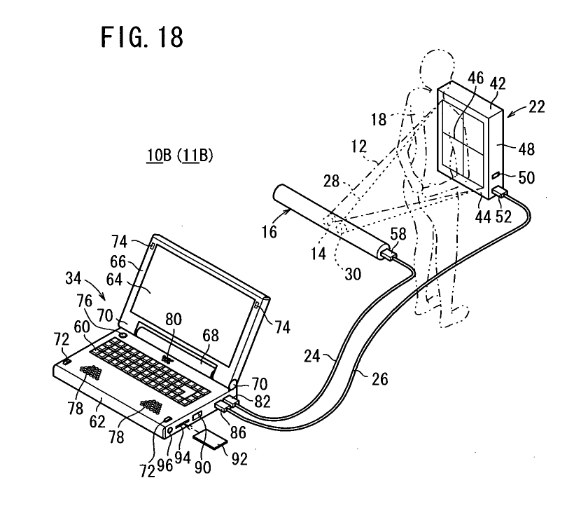

As shown in FIG. 18, a radiographic image capturing apparatus 10B and a radiographic image capturing system 11B according to a second modification are different from the radiographic image capturing apparatus and the radiographic image capturing systems shown in FIGS. 1 through 17 in that the web camera 30 is incorporated in the radiation source device 16 and captures an image having the guide lines 46 serving as the imaging area 28.

Thus, the web camera 30 and the radiation source device 16 are integrally combined in the second modification. The integral structure of the web camera 30 and the radiation source device 16 is not limited to the structure in which the radiation source device 16 has a built-in web camera 30 shown in FIG. 18, but may include the structure in which a radiation source device 16 integrally connected to a web camera 30 at least at the time the radiographic image capturing apparatus 10B is in use. Specifically, the integral structure of the web camera 30 and the radiation source device 16 includes the cases: (1) the web camera 30 and the radiation source device 16 are electrically connected to each other by a cable attached to the radiographic image capturing apparatus 10B; (2) the web camera 30 and the radiation source device 16 are connected to each other by cables prepared by the operator 32; and (3) the web camera 30 and the radiation source device 16 are connected to each other when in use, whereas the web camera 30 and the radiation source device 16 are separable from each other during maintenance or when not in use.

Further, in the second modification, since the camera image captured by the web camera 30 displays only the guide lines 46, the doctor 38 can easily determine whether the body region of the subject 18 to be imaged is included in the outer frame of the guide lines 46 or not.

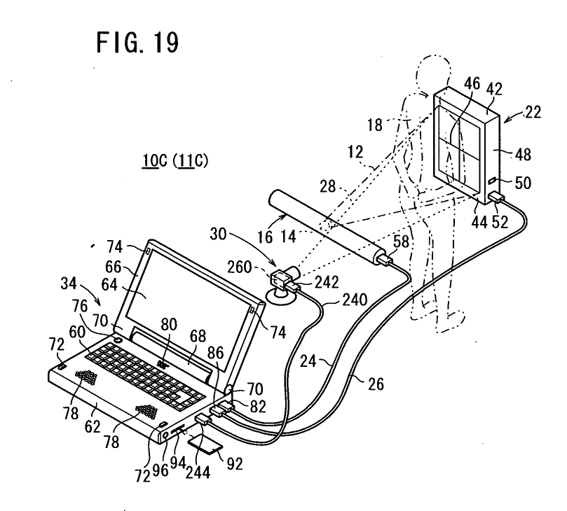

As shown in FIG. 19, a radiographic image capturing apparatus 100 and a radiographic image capturing system 11C according to a third modification are different from the radiographic image capturing apparatus and the radiographic image capturing systems shown in FIGS. 1 through 18 in that a separately provided web camera 30 is integrally coupled to the mobile information terminal 34 by electrically connecting the web camera 30 to the mobile information terminal 34 using a USB cable 240 having connectors 242, 244.

The web camera 30 is supplied with electric power from the battery 220 via the USB cable 240, and sends a captured camera image to the mobile information terminal 34 via the USB cable 240. Though the number of parts of the radiographic image capturing apparatus 100 is increase because the separately provided web camera 30 and mobile information terminal 34 are integrally coupled to each other, the radiographic image capturing apparatus 100 offers the same advantages as the radiographic image capturing apparatus 10 described above.

As shown in FIG. 19, the web camera 30 includes a communication unit 260. The communication unit 260 may sent signals representing camera images, radiographic image information, etc. to the communication unit 104 of the medical organization 40 via the network 36 (see FIG. 1).

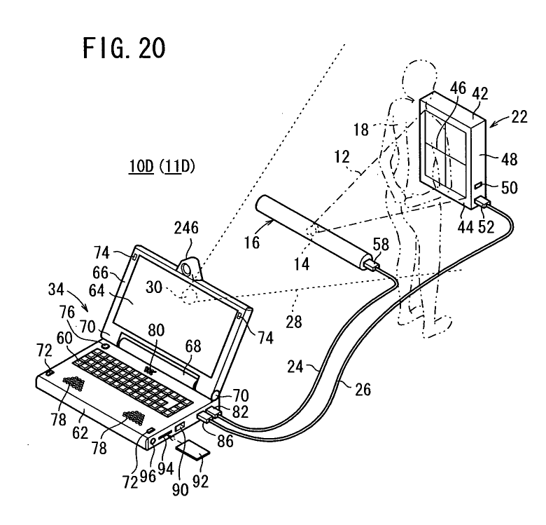

As shown in FIG. 20, a radiographic image capturing apparatus 10D and a radiographic image capturing system 11D according to a fourth modification are different from the radiographic image capturing apparatus and the radiographic image capturing systems shown in FIGS. 1 through 19 in that a web camera 246 for capturing an image of the operator 32 at the time the operator 32 operates the mobile communication terminal 34 is provided on the lid 66.

The mobile communication terminal 34 sends a camera image of the operator 32 captured by the web camera 246 to the medical organization 40 via the network 36. The operator 32 asks the doctor 38 for directions while seeing the image of the doctor 38 which is displayed on the display unit 64, and the doctor 38 gives directions to the operator 32 while seeing the image of the operator 32 which is displayed on the display unit 112. Therefore, the operator 32 can feel as if the doctor 38 in the medical organization 40 which is remote from the mobile communication terminal 34 is standing by the operator 32, and the doctor 38 can also feel as if the operator 32 at the site is standing by the doctor 38. The operator 32 and the doctor 38 thus feel easy in performing the preparatory procedure.

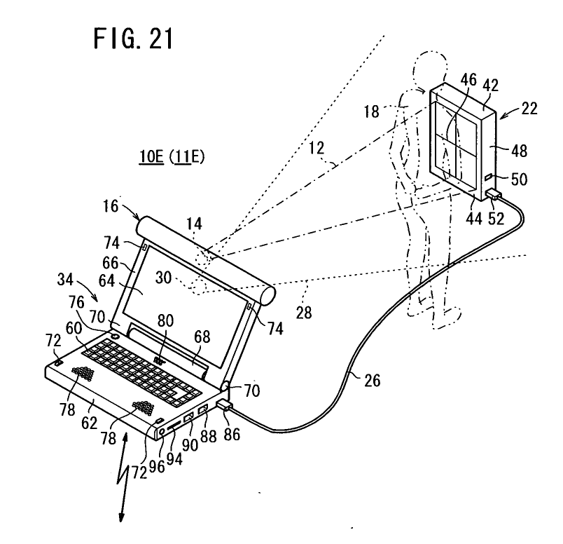

As shown in FIG. 21, a radiographic image capturing apparatus 10E and a radiographic image capturing system 11E according to a fifth modification are different from the radiographic image capturing apparatus and the radiographic image capturing systems shown in FIGS. 1 through 20 in that the radiation source device 16 is coupled to and integrally combined with the lid 66 of the mobile information terminal 34.

The radiographic image capturing apparatus 10E thus constructed can easily be assembled and disassembled on site because the USB cable 24 is dispensed with. As the radiation source device 16 and the mobile information terminal 34 are integrally combined with each other, the battery 134, the communication unit 136, and the radiation source controller 138 are also dispensed with. Specifically, the battery 220 is shared as the battery of the radiation source device 16, the control processor 222 is shared as the radiation source controller of the radiation source device 16, and the communication unit 218 is shared as the communication unit of the radiation source device 16. The radiation source device 16 is thus simplified, making it possible to reduce the size of the radiographic image capturing apparatus 10E.

Inasmuch as the radiation source device 16 and the mobile information terminal 34 are integrally combined with each other, the operator 32 can simultaneously adjust the position and direction of the radiation source device 16 with respect to the cassette 22 and the subject 18 while seeing the display unit 64 or by changing the position and direction of the mobile information terminal 34 while operating the operating unit 60. According to the fifth modification, therefore, it is easy to adjust the position and direction of the radiation source device 16 with respect to the cassette 22 and the subject 18.

In FIG. 21, the web camera 30 is incorporated in the lid 66. However, the web camera 30 may be incorporated in the radiation source device 16.

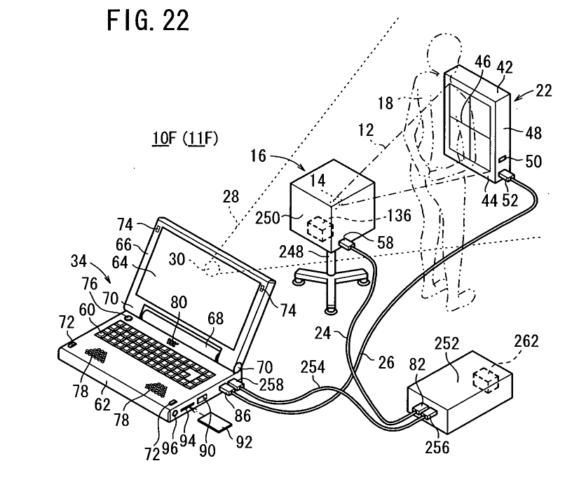

As shown in FIG. 22, a radiographic image capturing apparatus 10F and a radiographic image capturing system 11F according to a sixth modification are different from the radiographic image capturing apparatus and the radiographic image capturing systems shown in FIGS. 1 through 21 in that the radiation source 14 comprises a conventional thermionic-emission radiation source and the radiographic image capturing apparatus 10F includes a high-voltage power supply 252 for energizing a filament of the radiation source 14.

The radiation source 14 and the communication unit 136 are housed in a casing 250 mounted on the upper end of a stand 248, and the casing 250 is electrically connected to the high-voltage power supply 252 by the USB cable 24. The high-voltage power supply 252 and the mobile information terminal 34 are electrically connected to each other by a USB cable 254 having connectors 256, 258. The mobile information terminal 34 can control the high-voltage power supply 252 to cause the radiation source 14 to emit the radiation 12.

According to the sixth modification, the radiographic image capturing apparatus 10F is relatively large in size and has a relatively large number of parts because it includes the conventional thermionic-emission radiation source. However, the radiographic image capturing apparatus 10F offers the same advantages as those of the radiographic image capturing apparatus 10 shown in FIGS. 1 through 16.

As shown in FIG. 22, the high-voltage power supply 252 includes a communication unit 262 which may send and receive signals representing radiographic images, camera images, etc. to and from the communication unit 104 of the medical organization 40 via the network 36 (see FIG. 1).

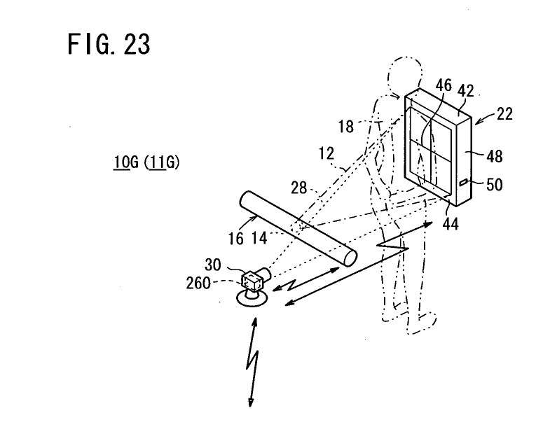

As shown in FIG. 23, a radiographic image capturing apparatus 10G and a radiographic image capturing system 11G according to a seventh modification are different from the radiographic image capturing apparatus and the radiographic image capturing systems shown in FIGS. 1 through 22 in that the mobile information terminal 34 is dispensed with and the web camera 30, the radiation source device 16, and the cassette 22 are separately provided and make up the radiographic image capturing apparatus 10G and send signals to and receive signals from each other by way of wireless communications.

Since the radiation source device 16, the cassette 22, and the web camera 30 are wirelessly connected to each other within one link, either one of the communication units 136, 170 (see FIG. 10) and the communication unit 260 of the web camera 30 may be used to send and receive signals representative of camera images and radiographic images to and from the communication unit 104 of the medical organization 40 (see FIG. 1). For example, the web camera 30 may send a camera image from the communication unit 260 directly to the medical organization 40 via the network 36 (see FIG. 1), or may send a camera image from the communication unit 260 indirectly to the medical organization 40 via the communication unit 136 of the radiation source device 16 or the communication unit 170 of the cassette 22.

The synchronization control signal is generated by the radiation source controller 138 of the radiation source device 16 or the cassette controller 168 of the cassette 22, or is supplied from the console 106 via the communication unit 104, the antenna 102, and the network 36.

The doctor 38 is able to see the camera image captured by the web camera 30. If the speakers 78 and the microphone 80 are incorporated in the web camera 30, the radiation source device 16, or the cassette 22, then the operator 32 may ask the doctor 38 for directions about the capture of radiographic images, and the doctor 38 may give directions to the operator 32. According to the seventh modification, since the display unit 64 is dispensed with, the operator 32 performs the preparatory procedure and other processes according to directions given from the doctor 38 based on sound messages output from the speakers 78.

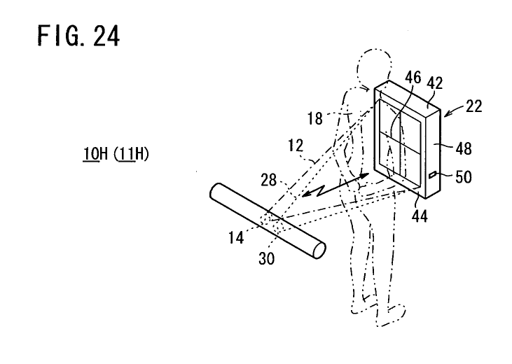

As shown in FIG. 24, a radiographic image capturing apparatus 10H and a radiographic image capturing system 11H according to an eighth, modification are different from the radiographic image capturing apparatus 10G and the radiographic image capturing system 11G shown in FIG. 23 in that the web camera 30 is incorporated in the radiation source device 16.

As with the second modification shown in FIG. 18, the web camera 30 incorporated in the radiation source device 16 captures an image having the guide lines 46 serving as the imaging area 28.

According to the eighth modification, since the radiation source device 16 and the cassette 22 are wirelessly connected to each other within one link, either one of the communication units 136, 170 (see FIG. 10) may be used to send and receive signals representative of camera images and radiographic images to and from the communication unit 104 of the medical organization 40 (see FIG. 1). For example, the web camera 30 may send a camera image from the communication unit 136 directly to the medical organization 40 via the network 36, or may send a camera image from the communication unit 136 indirectly to the medical organization 40 via the communication unit 170 of the cassette 22.

Since the web camera 30 is incorporated in the radiation source device 16, the number of parts of the radiographic image capturing apparatus 10H is reduced.

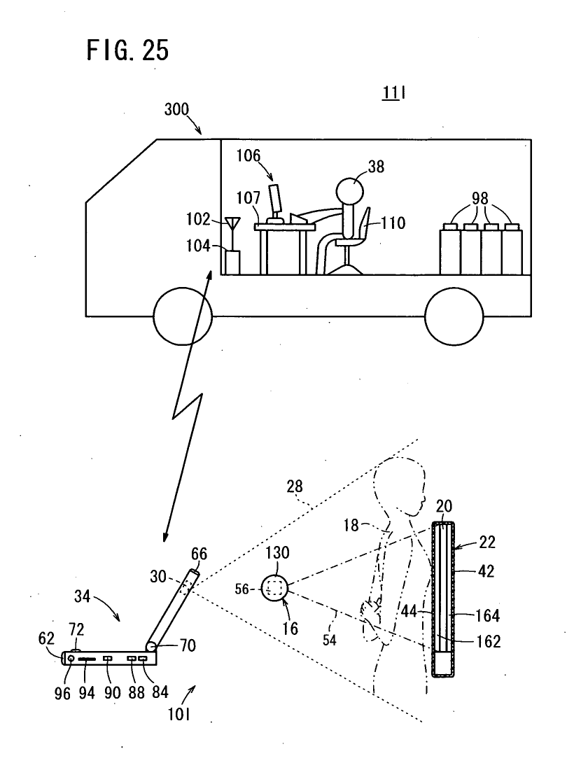

As shown in FIG. 25, a radiographic image capturing apparatus 10I and a radiographic image capturing system 11I according to a ninth modification are different from the radiographic image capturing apparatus and the radiographic image capturing systems shown in FIGS. 1 through 24 in that the console 106 and a plurality of attaché cases 98 each housing the radiographic image capturing apparatus 10I are provided in a medical examination car 300 (waiting place) on which the doctor 38 is available, and the operator 32 (see FIG. 5) carries at least one of the attaché case 98 from the medical examination car 300 to the site. The cabin of the medical examination car 300 where the doctor 38 is available serves as the waiting place from which the doctor 38 is unable to see the subject 18 directly.

The radiographic image capturing apparatus 10I that has been carried to the site and the communication unit 104 in the medical examination car 300 are capable of sending and receiving signals therebetween by way of wireless communications. For example, the radiographic image capturing apparatus 10I at the site can send wireless signals representing camera images and radiographic images to the communication unit 104 by way of wireless communications. Therefore, the radiographic image capturing apparatus 10I offers the same advantages as the radiographic image capturing apparatus shown in FIGS. 1 through 24. Though the radiographic image capturing apparatus 10I and the communication unit 104 are illustrated in FIG. 25 as sending and receiving signals directly therebetween by way of wireless communications, they may send and receive signals therebetween via the network 36 (see FIG. 1) by way of wireless communications.

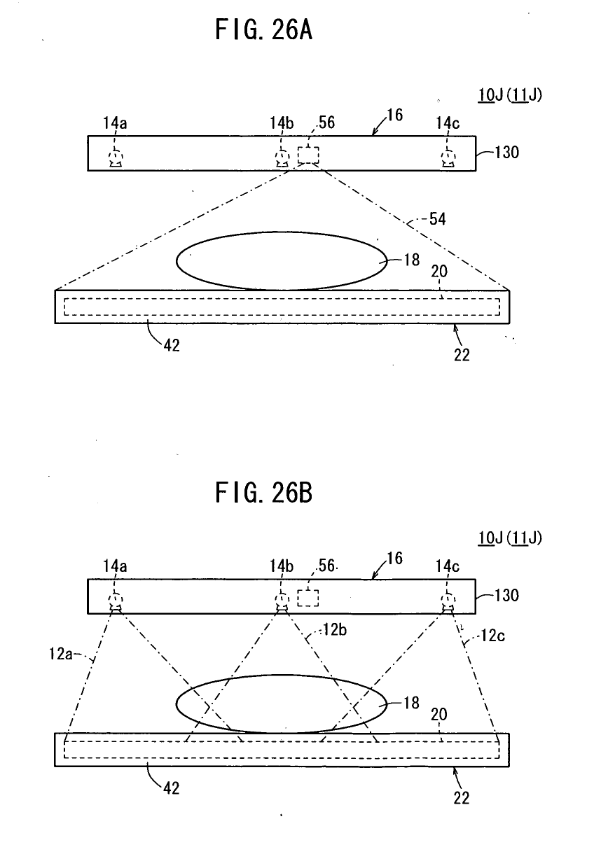

As shown in FIGS. 26A through 30B, a radiographic image capturing apparatus 10J and a radiographic image capturing system 11J according to a tenth modification are different from the radiographic image capturing apparatus and the radiographic image capturing systems shown in FIGS. 1 through 25 in that the radiation source device 16 applies radiations 12a through 12c through the subject 18 to the cassette 22 simultaneously or successively in irradiated ranges which are smaller than the radiation 12 (see FIG. 1).

The tenth modification is effective in capturing radiographic images of the subject 18 with the radiations 12a through 12c applied in the irradiated ranges which are smaller than the radiation 12 when the radiation intensity is set to a weak level and the radiation source device 16 is positioned closely to the cassette 22 for a small SID for better safety against unwanted exposure to the radiation in disaster sites or homes receiving home-care services.

In FIGS. 26A and 26B, the radiation source device 16 houses therein a plurality of radiation sources 14a, 14b, 14c spaced at certain intervals for simultaneously applying the respective radiations 12a, 12b, 12c to the irradiated surface 44 of the cassette 22 after the irradiated field lamp 56 outputs the irradiation light 54. The radiation sources 14a, 14b, 14c simultaneously output the respective radiations 12a, 12b, 12c such that the areas irradiated by the radiations 12a, 12b partly overlap each other and the areas irradiated by the radiations 12b, 12c partly overlap each other. The radiations 12a, 12b, 12c thus applied cover the entire area within the outer frame provided by the guide lines 46, reliably without any radiation-free gaps in the area. Even if the radiation intensity is set to a weak level, therefore, it is possible to reliably capture a radiographic image of the subject 18.

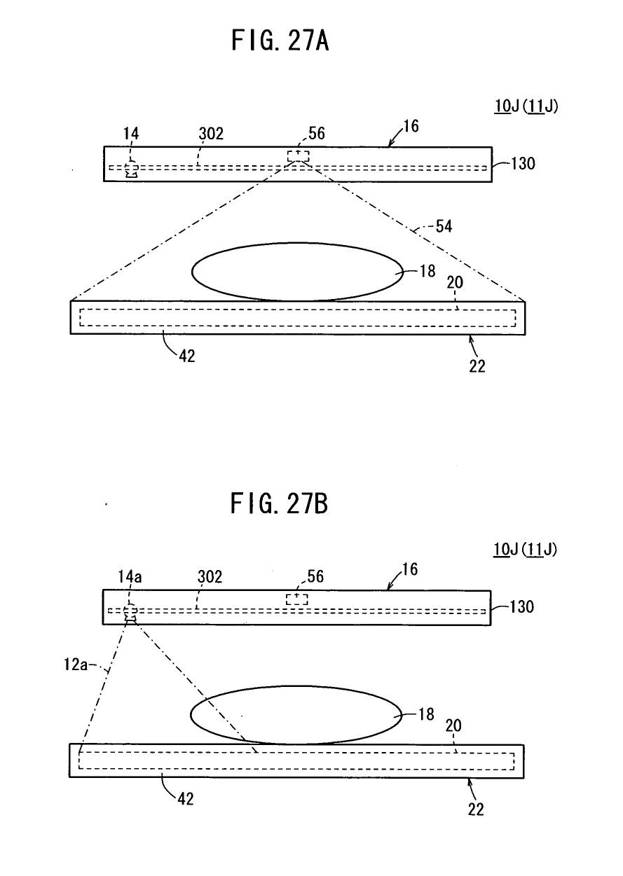

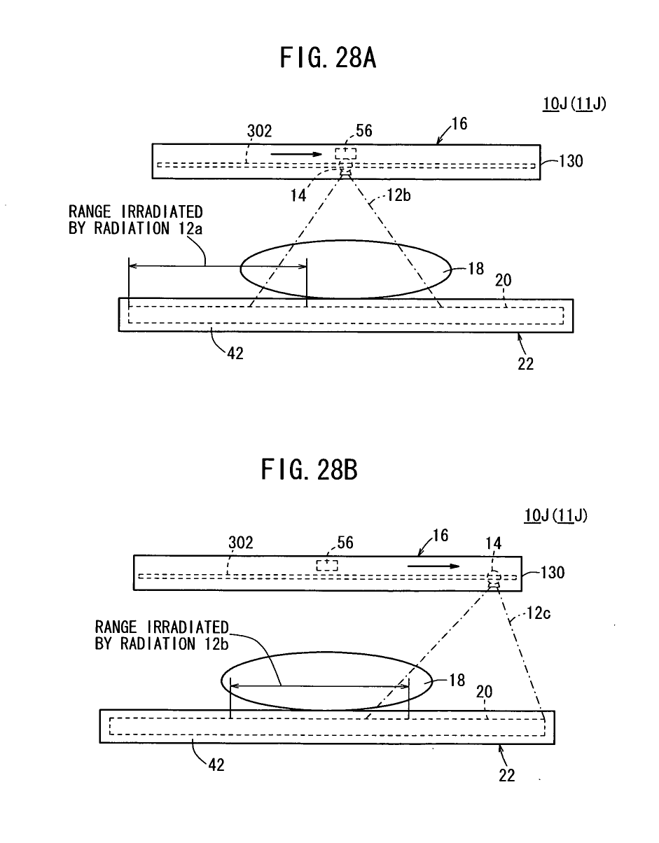

In FIGS. 27A through 28B, the radiation source device 16 houses therein a rail 302 extending longitudinally therealong, and the radiation source 14 is movable along the rail 302. After the irradiated field lamp 56 outputs the irradiation light 54 to the irradiated surface 44, the radiation source 14 repeatedly moves to certain positions along the rail 302 and applies the radiations 12a, 12b, 12c from respective positions after the radiation source 14 has moved to the certain positions along the rail 302. The radiation source 14 moves to the positions shown respectively in FIGS. 27B, 28A, and 28B and applies the radiations 12a, 12b, 12c from those positions such that the areas irradiated by the radiations 12a, 12b partly overlap each other and the areas irradiated by the radiations 12b, 12c partly overlap each other. The radiations 12a, 12b, 12c thus applied cover the entire area within the outer frame provided by the guide lines 46, reliably without any radiation-free gaps in the area. Even if the radiation intensity is set to a weak level, therefore, it is possible to reliably capture a radiographic image of the subject 18.

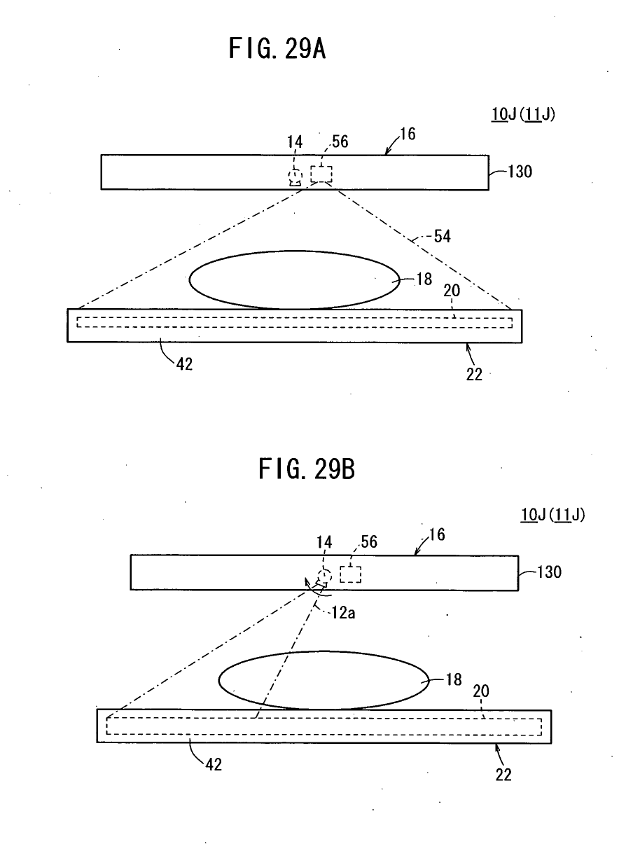

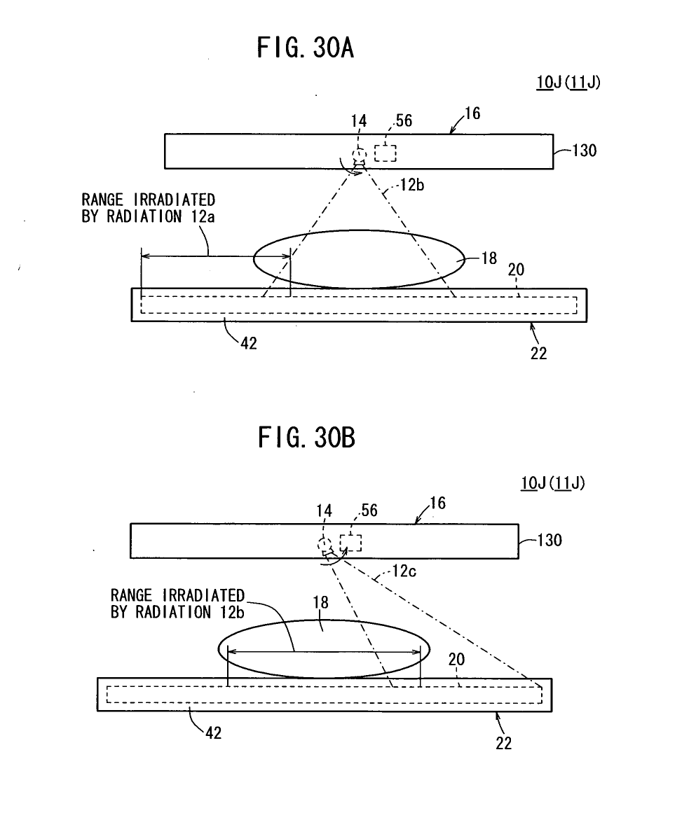

In FIGS. 29A through 30B, after the irradiated field lamp 56 outputs the irradiation light 54 to the irradiated surface 44, the radiation source 14 is repeatedly turned to certain angular positions by a turning mechanism, not shown, and applies the radiations 12a, 12b, 12c from respective positions after the radiation source 14 has been turned to the certain angular positions. The radiation source 14 is turned to the angular positions shown in FIGS. 29B, 30A, and 30B and applies the radiations 12a, 12b, 12c from those angular positions such that the areas irradiated by the radiations 12a, 12b partly overlap each other and the areas irradiated by the radiations 12b, 12c partly overlap each other. The radiations 12a, 12b, 12c thus applied cover the entire area within the outer frame provided by the guide lines 46, reliably without any radiation-free gaps in the area. Even if the radiation intensity is set to a weak level, therefore, it is possible to reliably capture a radiographic image of the subject 18.

In the tenth modification, the portions of the generated radiographic image which correspond to the overlapping areas irradiated by the radiations 12a, 12b, 12c may be corrected by a known correcting process such as a shading process or the like. In the arrangements shown in FIGS. 27A through 30B, at least two of the radiation sources 14a, 14b, 14c may be employed to apply the radiations to cover the entire area within the outer frame provided by the guide lines 46, reliably without any radiation-free gaps in the area, and the sequence in which the radiation source 14 is moved or turned, the positions to which the radiation source 14 is moved, and the angular positions to which the radiation source 14 is turned are not limited to those shown in FIGS. 27A through 28B and FIGS. 29B through 30B, but may be changed appropriately.

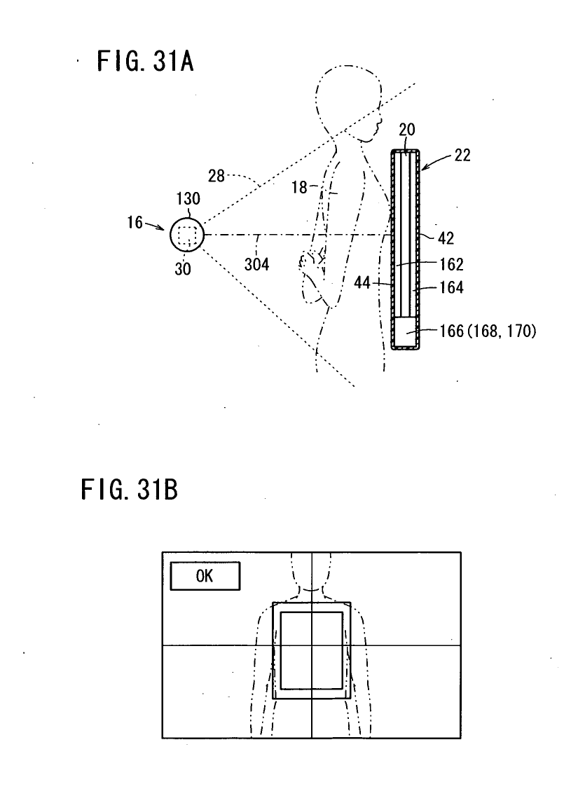

In FIGS. 31A through 33B, the subject 18 is positioned using the web camera 30 incorporated in the radiation source device 16, and a positional deviation of the radiation source device 16 is detected based on the camera image captured by the web camera 30 in the second modification and the eighth modification.

As shown in FIG. 31A, if a horizontal axis 304 extending through the center of the web camera 30 is substantially perpendicular to the central position of the guide lines 46, then the body region of the subject 18 to be imaged and the cassette 22 are displayed centrally in the camera image that is displayed on the display unit 64 (see FIG. 1) of the mobile information terminal 34 and the display unit 112 of the console 106, as shown in FIG. 31B. In FIG. 31B, the point of intersection of the crisscross lines in the camera image represents the central position of the guide lines 46. When the horizontal axis 304 is substantially perpendicular to the central position of the guide lines 46, the point of intersection of the crisscross lines in the camera image is substantially aligned with the central position of the guide lines 46.

In the preparatory procedure, the operator 32 instructs the subject 18 to move or adjusts the position of the radiation source device 16 to bring the point of intersection of the crisscross lines into substantial alignment with the central position of the guide lines 46 while seeing the camera image. Therefore, the operator 32 can easily position the subject 18 even without directly seeing the subject 18. In FIG. 31B, a visual message “OK” indicating that the preparatory procedure is completed is displayed when the point of intersection of the crisscross lines is in substantial alignment with the central position of the guide lines 46, as is the case with the displayed images shown in FIGS. 14A and 14B.

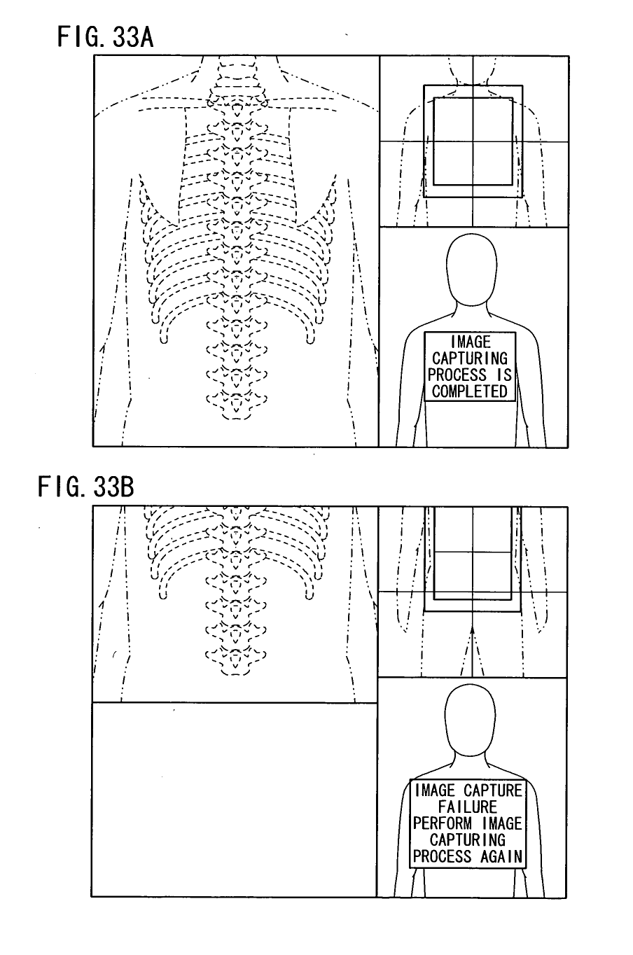

When the image capturing process is performed on the subject 18 which has been positioned as shown in FIGS. 31A and 31B, a radiographic image of the desired body region is obtained as shown in FIG. 33A. FIG. 33A shows images displayed on the display units 64, 112 after the image capturing process is performed. In FIG. 33A, the radiographic image of the body region of the subject 18 to be imaged is displayed at an enlarged scale, and a camera image of the subject 18 and the cassette 22 after the image capturing process is performed are displayed at a reduced scale together with a visual message “IMAGE CAPTURING PROCESS IS COMPLETED” indicating that the image capturing process is completed, as is the case with the displayed images shown in FIGS. 15A and 15B. After the image capturing process is performed, it is desirable for the doctor 38 to quickly analyze the radiographic image of the subject 18 in detail for diagnosis. The radiographic image of the body region of the subject 18 to be imaged that is displayed at a scale greater than the other images allows the doctor 38 to quickly and efficiently analyze the radiographic image for diagnosis.

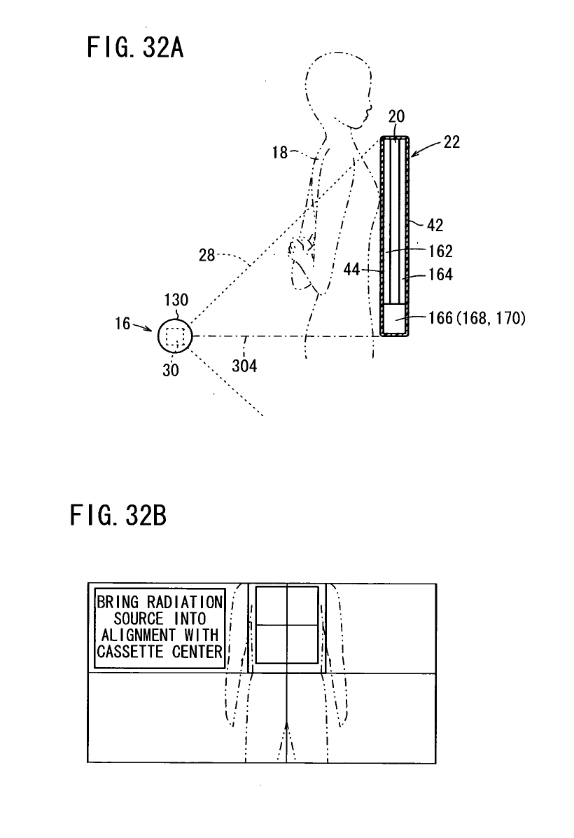

If the horizontal axis is not perpendicular to the central position of the guide lines 46, but deviates widely therefrom, as shown in FIG. 32A, then it is easy to recognize that the point of intersection of the crisscross lines in the camera image is not in alignment with the central position of the guide lines 46 and the radiation source device 16 positionally deviates from the cassette 22.

In the preparatory procedure, the operator 32 may adjust the position of the radiation source device 16 in order to bring the point of intersection of the crisscross lines into substantial alignment with the central position of the guide lines 46, i.e., in order to display the image shown in FIG. 31B, while seeing the camera image. The operator 32 can reliably be notified of positional deviations of the radiation source device 16 with respect to the cassette 22. In FIG. 32B, when the radiation source device 16 positionally deviates from the cassette 22, a visual message “MOVE PATIENT TO CASSETTE” indicating that the preparatory procedure is to be performed again is displayed as is the case with the displayed image shown in FIG. 14C.

If the image capturing process is performed despite the displayed image shown in FIG. 32B or if the radiation source device 16 positionally deviates in the image capturing process, then the display units 64, 112 display a failure radiographic image, a camera image of the subject 18 and the cassette 22 after the image capturing process, and a visual message “IMAGE CAPTURE FAILURE, PERFORM IMAGE CAPTURING PROCESS AGAIN” indicating that the image capturing process is to be performed again, as is the case with the displayed image shown in FIG. 15C. Therefore, the operator 32 easily recognizes that the image capturing process has failed and is to be performed again by seeing the displayed images.

With the arrangement shown in FIGS. 31A through 33B, the subject 18 is positioned using the web camera 30 incorporated in the radiation source device 16, and a positional deviation of the radiation source device 16 is detected based on the camera image captured by the web camera 30. Therefore, it is possible to reliably notify the operator 32 of the positional deviation in the preparatory procedure. The operator 32 can thus perform the preparatory procedure and reliably acquire desired radiation images. Even in the event of an image capturing process failure, the operator 32 can quickly perform the image capturing process again because the operator 32 is reliably notified of an instruction to perform the image capturing process again.

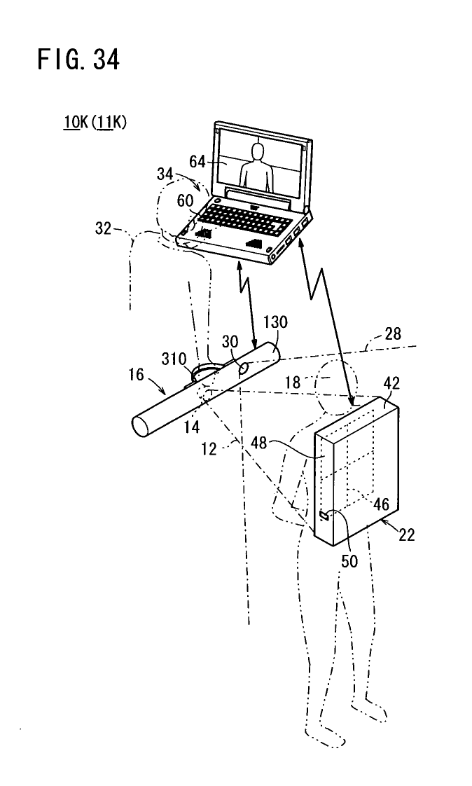

As shown in FIGS. 34 through 36B, a radiographic image capturing apparatus 10K and a radiographic image capturing system 11K according to an eleventh modification are different from the radiographic image capturing apparatus and the radiographic image capturing systems shown in FIGS. 1 through 33B in that a handle 310 to be gripped by the operator 32 is disposed on a portion opposite to the portion from which the radiation 12 is emitted.

In this case, the operator 32 directs the radiation source device 16 having a built-in web camera 30 toward the subject 18 and the cassette 22 while gripping the handle 310 with one hand, and operates the mobile information terminal 34 with the other hand while looking at the display unit 64. At this time, because the camera image captured by the web camera 30 is displayed on the display unit 64, the operator 32 can move the radiation source device 16 to a desired position and can position the subject 18, while looking at the captured camera image. Further, even if the radiation 12 is emitted while the operator 32 is gripping the handle 310, irradiation of the radiation 12 to the operator 32 (exposure to radiation) can reliably be avoided.

Particularly, at a disaster site surrounded by many obstacles, the eleventh modification is advantageous. Since the disaster site is full of obstacles and further it is difficult to move the subject 18 suffering from injuries or the like, it is not practical to fix the radiation source device 16 and the cassette 22 to predetermined locations and place the subject 18 between the radiation source device 16 and the cassette 22. In most cases, the radiation source device 16 and the cassette 22 have to be arranged depending on the subject 18. Therefore, even though the operator 32 can direct the radiation source device 16 toward the subject 18, the operator may not see the subject 18 directly because of the obstacles, making it difficult to place the subject 18 in the right position.

Thus, in the eleventh modification, when the operator 32 grips the handle 310 with one hand to direct the radiation source device 16 toward the subject 18 and the cassette 22 at a disaster site, the web camera 30 captures images of the subject 18 and the cassette 22, and then the captured camera images are displayed on the display unit 64. Accordingly, the operator 32 can easily operate the mobile information terminal 34 with the other hand, adjust the position of the radiation source device 16 or place the subject 18 in the right position, while looking at the displayed camera images on the display unit 64.

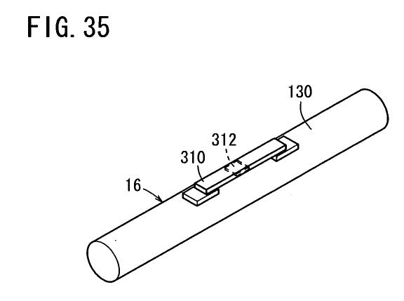

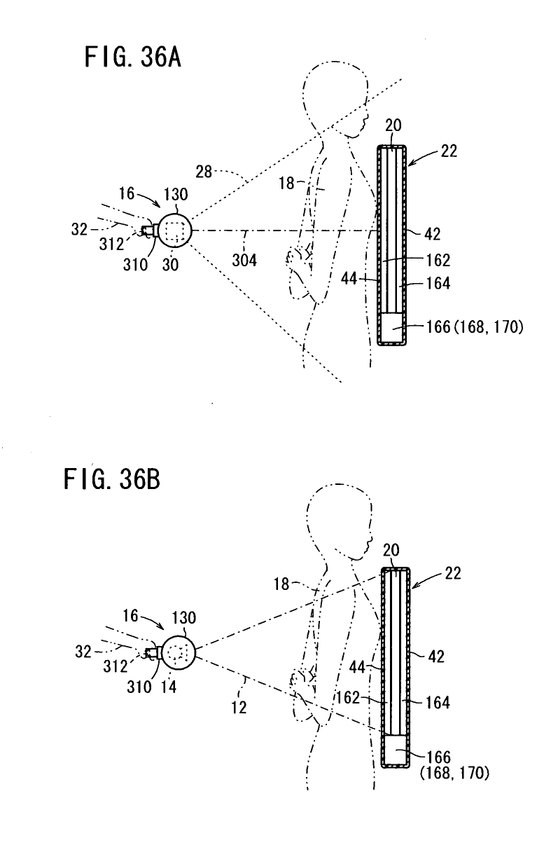

Also, the handle 310 is provided with a capacitive or resistive touch sensor 312 (see FIGS. 35 through 36B). When the operator 32 grips the handle 310, the palm of the operator 32 touches an electrode (not shown) of the touch sensor 312. Based on the contact between the palm and the electrode, the touch sensor 312 outputs a detection signal to the radiation source controller 138 and the cassette controller 222 (see FIG. 10). Upon receipt of the detection signal, the radiation source controller 138 or the cassette controller 222 may activate the radiation source device 16 or energize the cassette 22.

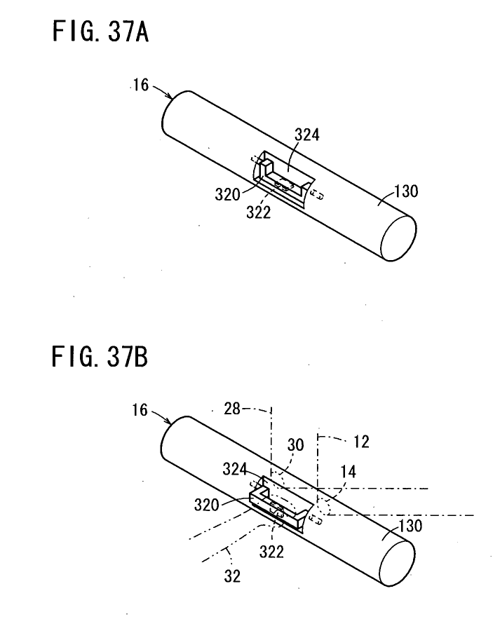

Further, as shown in FIGS. 37A and 37B, a recess 324 may be formed in a portion opposite to the portion from which the radiation 12 is emitted, so as to retractably provide a handle 320 in the recess 324. The handle 320 may also be provided with a touch sensor 322 functioning as with the touch sensor 312 described above. The handle 320 is housed within the recess 324 as shown in FIG. 37A while the operator 32 is not gripping the handle 320 of the radiation source device 16. On the other hand, when the operator 32 turns the handle 320 around its proximal side, the handle 320 projects from the recess 324 and allows the operator to grip the handle 320. In this case, the handle 320 and the touch sensor 322 offer the same advantages as the handle 310 and the touch sensor 312 described above.

The present invention is not limited to the structural details described above.

Specifically, the radiographic image capturing apparatus 10, 10A through 10K and the radiographic image capturing system 11, 11A through 11K may be arranged as described above and also as follows:

(1) The radiation source device 16, the cassette 22, the web camera 30, and the mobile information terminal 34 are included, the radiation source device 16 and the mobile information terminal 34 are separate from each other, and the web camera 30 is incorporated in the mobile information terminal 34 (see FIGS. 1 through 17, 20, 22, and 25).

(2) The radiation source device 16, the cassette 22, the web camera 30, and the mobile information terminal 34 are included, the radiation source device 16 and the mobile information terminal 34 are separate from each other, and the web camera 30 is incorporated in the radiation source device 16 (see FIGS. 18 and 34).

(3) The radiation source device 16, the cassette 22, the web camera 30, and the mobile information terminal 34 are included, the radiation source device 16 and the mobile information terminal 34 are separate from each other, and the web camera 30 is separate from the radiation source device 16, the cassette 22, and the mobile information terminal 34.

(4) The radiation source device 16, the cassette 22, the web camera 30, and the mobile information terminal 34 are included, the radiation source device 16 and the mobile information terminal 34 are integrally combined with each other, and the web camera 30 is incorporated in the mobile information terminal 34 (see FIG. 21).

(5) The radiation source device 16, the cassette 22, the web camera 30, and the mobile information terminal 34 are included, the radiation source device 16 and the mobile information terminal 34 are integrally combined with each other, and the web camera 30 is incorporated in the radiation source device 16.

(6) The radiation source device 16, the cassette 22, the web camera 30, and the mobile information terminal 34 are included, the radiation source device 16 and the mobile information terminal 34 are integrally combined with each other, and the web camera 30 is separate from the radiation source device 16, the cassette 22, and the mobile information terminal 34.

(7) The radiation source device 16, the cassette 22, and the web camera 30 are included, and the radiation source device 16 and the web camera 30 are separate from each other (see FIG. 23).

(8) The radiation source device 16, the cassette 22, and the web camera 30 are included, and the radiation source device 16 and the web camera 30 are integrally combined with each other (see FIGS. 24, 31A, and 32A).

In the above arrangements (1) through (8), the camera image captured by the web camera 30 is sent from either one of the communication unit 136 of the radiation source device 16, the communication unit 170 of the cassette 22, (the communication unit 218 of the mobile information terminal 34, the communication unit 262 of the high-voltage power supply 252), and the communication unit 260 of the web camera 30 to the communication unit 104 of the medical organization 40 via the network 36. In other words, the either one of the communication units functions as a camera image communication unit for sending a camera image.

In the above arrangements (1) through (8), radiographic image information output from the radiation detector 20 is sent from either one of the communication unit 136 of the radiation source device 16, the communication unit 170 of the cassette 22, (the communication unit 218 of the mobile information terminal 34, the communication unit 262 of the high-voltage power supply 252), and the communication unit 260 of the web camera 30, if any, to the communication unit 104 of the medical organization 40 via the network 36.

In the above arrangements (1) through (8), therefore, signals that are to be sent and received between the radiographic image capturing apparatus 10, 10A through 10J and the communication unit 104 of the medical organization 40 via the network 36 are sent and received between either one of the communication unit 136 of the radiation source device 16, the communication unit 170 of the cassette 22, (the communication unit 218 of the mobile information terminal 34, the communication unit 262 of the high-voltage power supply 252), and the communication unit 260 of the web camera 30, if any, and the communication unit 104.

In the illustrated embodiment and modifications, signals are sent and received by way of wireless communications and/or wired communications. However, if the subject 18 is held in contact with the radiation source device 16 and the cassette 22 with a short SID, then signals, e.g., a synchronization control signal, may be sent and received between the radiation source device 16 and the cassette 22 by way of intrabody communications through the subject 18 that serves as a signal transmission medium.

In a case where the operator 32 contacts both the radiation source device 16 and the mobile information terminal 34 as in the case of the eleventh modification (see FIGS. 34 through 37B), signals may be sent and received between the radiation source device 16 and the mobile information terminal 34 by way of intrabody communications through the operator 32 that serves as a signal transmission medium.

Although certain preferred embodiments of the present invention have been shown and described in detail, it should be understood that various changes and modifications may be made therein without departing from the scope of the appended claims.

What is claimed is:

1. A radiographic image capturing apparatus comprising:
a radiation source for outputting a radiation;
a radiation detector for detecting the radiation which is transmitted through a subject when the subject is irradiated with the radiation by the radiation source, and converting the detected radiation into a radiographic image;
a cassette housing the radiation detector therein, the cassette being permeable to the radiation;
a camera for capturing an image of at least the cassette; and
a camera image communication unit for sending the image of the cassette which is captured by the camera to a waiting-place communication unit, the waiting-place communication unit being disposed in a waiting place where a doctor or radiological technician who has the legal authority about application of the radiation to the subject waits and is unable to see the subject directly.

2. A radiographic image capturing apparatus according to claim 1, wherein the camera captures an image of at least an irradiated area on an irradiated surface of the cassette 22 which is irradiated by the radiation, the irradiated area being irradiated by the radiation and depending on the radiation detector; and
the camera image communication unit sends the image of the irradiated area which is captured by the camera to the waiting-place communication unit.

3. A radiographic image capturing apparatus according to claim 2, further comprising
a radiation source device housing the radiation source therein,
wherein the camera is integrally combined with the radiation source device or is separate from the radiation source device and the cassette; and
the camera image communication unit is integrally combined with the radiation source device, the cassette, or the camera, or is separate from the radiation source device, the cassette, and the camera.

4. A radiographic image capturing apparatus according to claim 3, further comprising
a controller for controlling the radiation source device and the cassette,
wherein the camera is mounted on the controller or the radiation source device, or is separate from the controller, the radiation source device, and the cassette; and
the camera image communication unit is mounted on the controller, the radiation source device, the cassette, or the camera, or is separate from the controller, the radiation source device, the cassette, and the camera.

5. A radiographic image capturing apparatus according to claim 4, wherein the controller and the radiation source device are integrally combined with each other or separate from each other.

6. A radiographic image capturing apparatus according to claim 4, wherein the controller includes a controller battery for energizing the controller;
the radiation source device includes a radiation source battery for energizing the radiation source;
the cassette includes a cassette battery for energizing the radiation detector; and
the controller battery is capable of charging the radiation source battery and/or the cassette battery.

7. A radiographic image capturing apparatus according to claim 4, wherein the radiation source device includes a radiation source communication unit for communicating with an external circuit;
the cassette includes a cassette communication unit for communicating with an external circuit;
the controller includes a controller communication unit for communicating with an external circuit; and
either one of the controller communication unit, the radiation source communication unit, and the cassette communication unit functions as the camera image communication unit to send the image of the irradiated area which is captured by the camera to the waiting-place communication unit, or the camera image communication unit is separate from the controller communication unit, the radiation source communication unit, and the cassette communication unit.

8. A radiographic image capturing apparatus according to claim 7, wherein the controller communication unit, the radiation source communication unit, and the cassette communication unit communicate with each other by way of wired communications, and the controller communication unit and the radiation source communication unit are electrically connected to each other and the controller communication unit and the cassette communication unit are electrically connected to each other by communication cables.

9. A radiographic image capturing apparatus according to claim 7, wherein the cassette communication unit sends the radiographic image directly to the waiting-place communication unit or sends the radiographic image to the waiting-place communication unit via the controller communication unit, the radiation source communication unit, and/or the camera image communication unit.

10. A radiographic image capturing apparatus according to claim 9, wherein the camera image communication unit and the waiting-place communication unit send and receive the image of the irradiated area therebetween by way of wireless communications and/or wired communications, and the cassette communication unit and the waiting-place communication unit send and receive the radiographic image therebetween by way of wireless communications and/or wired communications.

11. A radiographic image capturing apparatus according to claim 10, further comprising
a console disposed in the waiting place, the console being electrically connected to the waiting-place communication unit,
wherein the waiting-place communication unit outputs the received image of the irradiated area and/or the radiographic image to the console.

12. A radiographic image capturing apparatus according to claim 11, wherein the console includes an exposure switch for starting to output the radiation from the radiation source;
wherein the console sends an exposure control signal to start to output the radiation via the waiting-place communication unit to the radiation source communication unit in a case where the exposure switch is turned on; and
the radiation source starts to output the radiation in a case where the radiation source communication unit receives the exposure control signal.

13. A radiographic image capturing apparatus according to claim 12, wherein the controller includes at least one of a display unit for displaying the image of the irradiated area and/or the radiographic image, and a sound output unit for outputting a sound.

14. A radiographic image capturing apparatus according to claim 13, wherein in a case where the image of the irradiated area outputted to the console before the radiation source outputs the radiation does not include a body region of the subject to be imaged or includes only a portion of the body region of the subject to be imaged, the console does not output the exposure control signal to the waiting-place communication unit, and sends a direction signal for instructing the radiographic image capturing apparatus to include the body region of the subject to be imaged in the image of the irradiated area, to the controller communication unit via the waiting-place communication unit; and
the controller displays a direction indicated by the direction signal on the display unit and/or outputs a sound depending on the direction indicated by the direction signal from the sound output unit, based on the direction signal received by the controller communication unit.

15. A radiographic image capturing apparatus according to claim 1, wherein the camera image communication unit sends a moving image or a still image of the cassette which is captured by the camera, or still images of the cassette which are captured at predetermined time intervals by the camera, to the waiting-place communication unit.

16. A radiographic image capturing apparatus according to claim 15, wherein the camera comprises an optical camera.

17. A radiographic image capturing apparatus according to claim 16, wherein the camera comprises a web camera.

18. A radiographic image capturing system comprising:
a radiographic image capturing apparatus including a radiation source for outputting a radiation, a radiation detector for detecting the radiation which is transmitted through a subject when the subject is irradiated with the radiation by the radiation source, and converting the detected radiation into a radiographic image, a cassette housing the radiation detector therein, the cassette being permeable to the radiation, a camera for capturing an image of at least the cassette, and a camera image communication unit for sending the image of the cassette which is captured by the camera to an external circuit;
a waiting-place communication unit for receiving the image of the cassette from the camera image communication unit, the waiting-place communication unit being disposed in a waiting place where a doctor or radiological technician who has the legal authority about the application of the radiation to the subject waits and is unable to see the subject directly; and
a console electrically connected to the waiting-place communication unit, for being supplied with the image of the cassette from the waiting-place communication unit.

19. A radiographic image capturing system according to claim 18, wherein the radiographic image capturing apparatus further includes a controller for generating a synchronization control signal to synchronize the outputting of the radiation from the radiation source and the conversion by the radiation detector from the radiation into the radiographic image with each other, and sending the generated synchronization control signal to the radiation source device and the cassette to control the radiation source device and the cassette.

20. A radiographic image capturing method comprising the steps of:
capturing an image of a cassette housing at least a radiation detector with a camera;
sending the image of the cassette which is captured by the camera to a waiting-place communication unit which is disposed in a waiting place where a doctor or radiological technician who has the legal authority about the application of a radiation to a subject waits and is unable to see the subject directly;
sending an instruction from the waiting-place communication unit to the radiation source to output the radiation thereby to cause the radiation source to output and apply the radiation to the subject, in a case where the image of the cassette sent to the waiting-place communication unit includes a body region of the subject to be imaged; and
detecting the radiation which is transmitted through the subject and the cassette and converting the detected radiation into a radiographic image with the radiation detector.
